(19) United States
(12) Patent Application Publication
(10) Pub. No.: US 2026/0119921 A1
(43) Pub. Date: Apr. 30, 2026

(54) DYNAMIC AND ADAPTIVE OPTIMIZATION OF ARTIFICIAL INTELLIGENCE AGENTS AT INFERENCE TIME

(71) Applicant: BOOMI, LP, Conshohocken, PA (US)

(72) Inventors: Michael BACHMAN, Bala Cynwyd, PA (US); Michael J. HUDSON, Delray Beach, FL (US)

(73) Assignee: BOOMI, LP, Conshohocken, PA (US)

(21) Appl. No.: 19/325,908

(22) Filed: Sep. 11, 2025

(30) Foreign Application Priority Data
Oct. 25, 2024 (IN) 202411081537
Oct. 25, 2024 (IN) 202411081538

(51) Int. Cl. G06N 5/04

(52) U.S. Cl. CPC G06N 5/04

(57) ABSTRACT

Current agentic systems are unable to balance the costs of artificial intelligence (AI) agents with performance. Disclosed embodiments introduce a scoring AI agent, which scores deviations between the actual performance of a performing AI agent and the expected performance of the performing AI agent. When this deviation becomes substantial, the scoring AI agent may modify parameter(s) in an adaptive governance policy that governs operation of the performing AI agent. In this manner, an AI agent can be automatically throttled down and/or up, as real-time conditions evolve.

### CROSS-REFERENCE TO RELATED APPLICATIONS

The present application claims priority to Indian Patent Application No. 202411081537, filed on Oct. 25, 2024, and Indian Patent Application No. 202411081538, filed on Oct. 25, 2024, which are both hereby incorporated herein by reference as if set forth in full.

### BACKGROUND

### Field of the Invention

The embodiments described herein are generally directed to artificial intelligence (AI), and, more particularly, to dynamically and adaptively optimizing the performance of AI agents at inference time.

### Description of the Related Art

A number of platforms provide infrastructure for the development and/or execution of AI agents. An AI agent is a software entity that utilizes artificial intelligence to autonomously perform one or more tasks, in order to achieve an objective set by a human, another software entity (e.g., another AI agent), or other system. An AI agent may comprise or communicate with one or more integrated, local, or remote AI models, such as generative AI models (e.g., generative language models, generative image models, generative coding models, etc.). An AI agent may also communicate with one or more tools that are external to the AI agent to complete tasks in furtherance of its objective. The AI agent may communicate with an AI model and/or tool using an application programming interface (API).

Some platforms provide tools for controlling the training and inference costs for AI agents. For example, the model context protocol (MCP) provides local latency reduction parameters. However, state-of-the-art approaches are limited to static settings, which cannot dynamically adapt to changing circumstances, and which are not implemented globally to manage agentic interactions.

In addition, these state-of-the-art approaches fail to balance performance optimization, resource utilization, and cost optimization, which is required to ensure that AI agents do not bankrupt an enterprise or cause brownouts on the power grid. For example, token-based communication is costly in terms of energy, runtime, and monetary resources. Nevertheless, AI agents have a job to do. Thus, finding a balance between performance and cost is important. However, striking this balance is difficult at an agentic level, since latency reduction is handled at each discrete level, and is defined by deterministic rules, designed for non-agentic AI systems, that are applied statically based on the profile of the resource, service, program, or the like, at the start of execution. Similarly, state-of-the-art cost optimization tools are built for non-agentic systems according to a static paradigm.

### SUMMARY

Accordingly, systems, methods, and non-transitory computer-readable media are disclosed for dynamic and adaptive optimization of AI agents at inference time.

In an embodiment, a method comprises using at least one hardware processor to, by a scoring artificial intelligence (AI) agent, while a performing AI agent is performing inference using a performing AI model: receive performance telemetry for the performing AI agent; determine a score representing a deviation between an actual performance of the performing AI agent and an expected performance of the performing AI agent based on the performance telemetry; and modify a value of each one or more parameters in an adaptive governance policy based on the score, wherein the adaptive governance policy governs operation of the performing AI agent, and wherein the modification of the value of each of the one or more parameters triggers a change in the operation of the performing AI agent while the performing AI agent is performing the inference.

The adaptive governance policy may comprise a plurality of parameters that are organized into a plurality of hierarchical levels. The plurality of hierarchical levels may comprise a first level that is specific to the performing AI agent, and at least one second level that represents a group of two or more performing AI agents.

The performing AI agent may be a conversational AI agent that converses with a user using natural language.

The performance telemetry may comprise one or both of a log or metadata for each of one or more components in a stack of the performing AI agent. The one or more components may be a plurality of components. The plurality of components may comprise two or more of a core of the performing AI agent, the performing AI model, a model router utilized by the performing AI agent, a tool utilized by the performing AI agent, or an inter-agent communication protocol utilized by the performing AI agent to communicate with other AI agents. Triggering the change in the operation of the performing AI agent may comprise communicating directly with one or more of the plurality of components.

The method may further comprise using the at least one hardware processor to, when the change in the operation is triggered, adjusting one or more configurable parameters of each of one or more components in a stack of the performing AI agent. The adjustment may be performed by the performing AI agent. The adjustment may be performed by a software entity, other than the performing AI agent, via an application programming interface of each of the one or more components. The one or more components may be a plurality of components. The plurality of components may comprise two or more of a core of the performing AI agent, the performing AI model, a model router utilized by the performing AI agent, a tool utilized by the performing AI agent, or an inter-agent communication protocol utilized by the performing AI agent to communicate with other AI agents

The scoring AI agent may receive the performance telemetry as a stream from an event-driven architecture. The event-driven architecture may be a publish-and-subscribe system.

The change in operation may comprise throttling down a utilization of one or more resources by the performing AI agent. Throttling down the utilization of one or more resources by the performing AI agent may comprise limiting the utilization of the one or more resources.

The performing AI model may comprise a generative language model.

It should be understood that any of the features in the methods above may be implemented individually or with any subset of the other features in any combination. Thus, to the extent that the appended claims would suggest particular dependencies between features, disclosed embodiments are not limited to these particular dependencies. Rather, any of the features described herein may be combined with any other feature described herein, or implemented without any one or more other features described herein, in any combination of features whatsoever. In addition, any of the methods, described above and elsewhere herein, may be embodied, individually or in any combination, in executable software modules of a processor-based system, such as a server, and/or in executable instructions stored in a non-transitory computer-readable medium.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates an example infrastructure, in which one or more of the processes described herein may be implemented, according to an embodiment;

FIG. 2 illustrates an example processing system, by which one or more of the processes described herein may be executed, according to an embodiment;

FIG. 3 illustrates an example data flow for dynamic and adaptive optimization of AI agents at inference time, according to an embodiment;

FIG. 4 illustrates an example process for dynamic and adaptive optimization of AI agents at inference time, according to an embodiment;

FIG. 5 illustrates an example data flow for dynamic and adaptive prediction of inference costs prior to the utilization of AI models, according to an embodiment;

FIG. 6 illustrates an example process for dynamic and adaptive prediction of inference costs prior to the utilization of AI models, according to an embodiment;

FIG. 7 illustrates an example data flow for decentralized autonomous agentic provider selection, according to an embodiment; and

FIG. 8 illustrates an example process for decentralized autonomous agentic provider selection, according to an embodiment.

### DETAILED DESCRIPTION

Embodiments of systems, methods, and non-transitory computer-readable media are disclosed for dynamic and adaptive optimization of AI agents at inference time. After reading this description, it will become apparent to one skilled in the art how to implement the invention in various alternative embodiments and alternative applications. However, although various embodiments of the present invention will be described herein, it is understood that these embodiments are presented by way of example and illustration only, and not limitation. As such, this detailed description of various embodiments should not be construed to limit the scope or breadth of the present invention as set forth in the appended claims.

### 1. Infrastructure

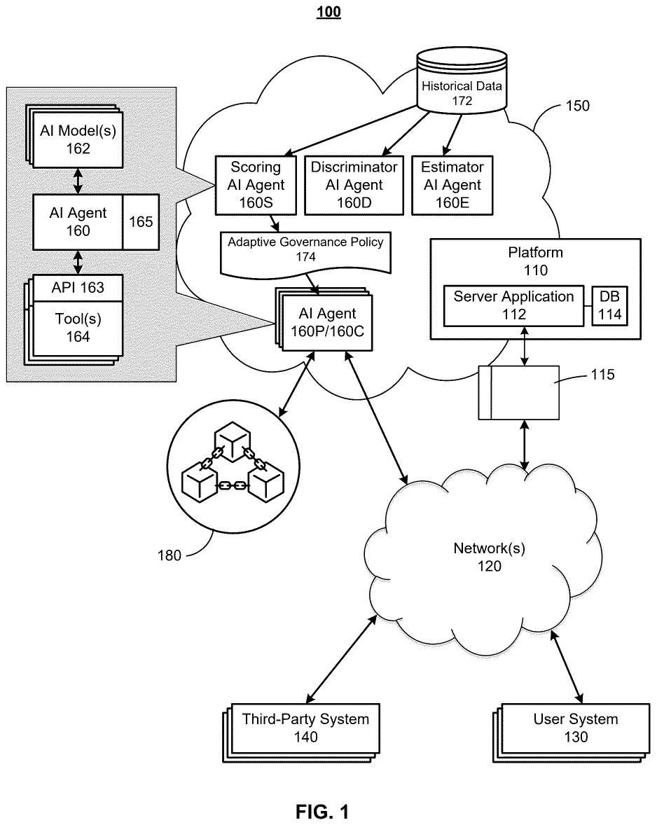

FIG. 1 illustrates an example infrastructure 100, in which one or more of the processes described herein may be implemented, according to an embodiment. While infrastructure 100 is illustrated with a variety of components, it should be understood that not every embodiment will require every component. Thus, none of the illustrated components should be construed as necessary to any embodiment, unless expressly stated herein. In addition, it should be understood that infrastructure 100 may comprise other components, in addition to those specifically illustrated and/or described herein.

Infrastructure 100 may comprise a platform 110 which hosts, supports, and/or executes one or more of the disclosed processes, which may be implemented in software and/or hardware. In particular, platform 110 may execute a server application 112, and may host or be communicatively coupled to a database 114 that may store data consumed and/or produced by server application 112. Platform 110 may comprise dedicated servers, or may instead be implemented in a computing cloud, in which the resources of one or more servers are dynamically and elastically allocated to multiple tenants based on demand. In either case, the servers may be collocated and/or geographically distributed.

Platform 110 may be communicatively connected to one or more networks 120. Network(s) 120 enable communication between platform 110 and one or more user systems 130 and/or third-party systems 140. Network(s) 120 may comprise the Internet, and communication through network(s) 120 may utilize standard transmission protocols, such as HTTP, HTTP Secure (HTTPS), File Transfer Protocol (FTP), FTP Secure (FTPS), Secure Shell FTP (SFTP), and the like, as well as proprietary protocols. While platform 110 is illustrated as being connected to a plurality of user systems 130 and/or third-party system(s) 140 through a single set of network(s) 120, it should be understood that platform 110 may be connected to different user systems 130 and/or third-party systems 140 via different sets of one or more networks. For example, platform 110 may be connected to a subset of user systems 130 and/or third-party systems 140 via the Internet, but may be connected to another subset of user systems 130 and/or third-party systems 140 via an intranet.

Server application 112 may manage a computing environment 150. In particular, server application 112 may provide a user interface 115 and backend functionality, including one or more of the processes disclosed herein, to enable or otherwise support users, via user systems 130, to construct, develop, modify, save, delete, test, deploy, un-deploy, utilize, and/or otherwise manage software entities within computing environment 150. User interface 115 may comprise a graphical user interface that implements a low-code environment, including potentially a no-code environment, in which users may construct or utilize software entities. These software entities may comprise AI agents 160, and potentially other software entities, such as integration processes.

While only a few user systems 130 are illustrated, it should be understood that platform 110 may be communicatively connected to any number of user system(s) 130 via network(s) 120. User system(s) 130 may comprise any type or types of computing devices capable of wired and/or wireless communication, including without limitation, desktop computers, laptop computers, tablet computers, smart phones or other mobile phones, servers, game consoles, televisions, set-top boxes, electronic kiosks, point-of-sale terminals, and/or the like. However, it is generally contemplated that a user system 130 would be the personal computer or professional workstation of a user, who has a user account for accessing server application 112 on platform 110 and/or computing environment 150 managed by server application 112. It should be understood that the user may be anywhere from an expert software engineer, with extensive knowledge of software, to a business decision-maker, lay person, or other non-technical person, with little to no knowledge of software.

The user of a user system 130 may authenticate with platform 110 using standard authentication means, to access server application 112 and/or computing environment 150 in accordance with roles or permissions of the associated user account. The user may then interact with server application 112 and/or one or more software entities within computing environment 150. It should be understood that multiple users, on multiple user systems 130, may manage or utilize the same software entities and/or different software entities in this manner, according to the permissions or roles of their associated user accounts. Each user account may be associated with an overarching organizational account for managing or utilizing software entities, such as AI agents 160, within computing environment 150.

Platform 110 may be an integration platform as a service (iPaaS) platform. In this case, the software entities(s) being developed may include integration process(es). Computing environment 150 may comprise one or a plurality of integration platforms that each comprises one or a plurality of integration processes. Each integration platform may be associated with an organization, which may be associated with one or more user accounts by which respective user(s) manage the organization's integration platform, including the various integration process(es). An integration process may represent a transaction involving the integration of data between two or more systems, and may comprise a series of elements that specify logic and transformation requirements for the data to be integrated. Each element, which may also be referred to as a “step,” may transform, route, and/or otherwise manipulate data to attain an end result from input data. For example, a basic integration process may receive data from one or more data sources (e.g., via an application programming interface of the integration process), manipulate the received data in a specified manner (e.g., including mapping, analyzing, normalizing, altering, updating, enhancing, and/or augmenting the received data), and send the manipulated data to one or more specified destinations (e.g., via an application programming interface of each destination). An integration process may represent a business workflow or a portion of a business workflow or a transaction-level interface between two systems, and comprise, as one or more elements, software modules that process data to implement the business workflow or interface. A business workflow may comprise any myriad of workflows of which an organization may repetitively have need. For example, a business workflow may comprise, without limitation, procurement of parts or materials, manufacturing a product, selling a product, shipping a product, ordering a product, billing, managing inventory or assets, providing customer service, ensuring information security, marketing, onboarding or offboarding an employee, assessing risk, obtaining regulatory approval, reconciling data, auditing data, providing information technology services, and/or any other workflow that an organization may implement in software. These integration processes, and/or the development and/or management of these integration processes, may be supported by one or more AI agents 160, and/or the integration processes may support AI agents 160, for example, as tools 164 that are utilized by AI agents 160.

Each AI agent 160 and/or integration process, when deployed, may be communicatively coupled to network(s) 120. For example, each of these software entities may comprise an application programming interface that enables clients to access the software entity, within computing environment 150, via network(s) 120. A client may push data to a software entity through the application programming interface, and/or pull data from a software entity through the application programming interface.

One or more third-party systems 140 may be communicatively connected to network(s) 120, such that each third-party system 140 may communicate with an AI agent 160 and/or integration process in computing environment 150 via an application programming interface. Third-party system 140 may host and/or execute a software application that pushes data to an AI agent 160 and/or integration process and/or pulls data from an AI agent 160 and/or integration process, via the application programming interface of the AI agent 160 or integration process. Additionally or alternatively, an AI agent 160 and/or integration process may push data to a software application on third-party system 140 and/or pull data from a software application on third-party system 140, via an application programming interface of the third-party system 140. Thus, third-party system 140 may be a client or consumer of one or more AI agents 160 and/or integration processes, a data source for one or more AI agents 160 and/or integration processes, and/or the like. As examples, the software application on third-party system 140 may comprise, without limitation, enterprise resource planning (ERP) software, customer relationship management (CRM) software, accounting software, and/or the like.

In an embodiment, the software entities(s) being managed and/or utilized within computing environment 150, via platform 110, include AI agents 160. An AI agent 160 is any software entity that utilizes artificial intelligence (e.g., machine learning, natural-language processing, data analytics, etc.), embodied in one or more AI models 162, to autonomously perform a task, in order to achieve an objective set by a human, other software entity, or other system. AI agent 160 may collect data, analyze data, communicate with human users and/or other software entities, collaborate with other AI agents 160 to complete a complex task, execute actions, learn and improve over time, and/or the like. AI agents 160 can have varying degrees of autonomy in creating their own rules, adjusting their behavior, planning, reasoning, acting, reacting, aligning itself with the goal of an end client, and/or the like, until an outcome is achieved.

Each AI agent 160 comprises or is communicatively coupled to at least one AI model 162. AI model 162 may be internal to AI agent 160, external but local (i.e., within computing environment 150) to AI agent 160, or external and remote (i.e., outside computing environment 150, e.g., hosted on third-party system 140, etc.) from AI agent 160. In an embodiment in which AI model 162 is external to AI agent 160, AI agent 160 may communicate with AI model 162 via a model router. A model router is an endpoint (e.g., a service invokable via an application programming interface) that, when called by AI agent 160, calls an AI model 162 deterministically (e.g., the same AI model 162 each time) or adaptively (e.g., dynamically selecting an AI model 162 each time) to produce a response.

AI model 162 may be a language model (e.g., small or large language model), reasoning model (e.g., large language model designed to break complex problems into smaller chain-of-thought steps), diffusion model (e.g., for image generation, time-series forecasting, data imputation, etc.), discriminative model (e.g., Markov model, support vector machine (SVM), artificial neural network, such as a convolutional neural network, etc.), or the like. In an embodiment, AI model 162 comprises a generative AI model, such as a generative language model (e.g., small language model, large language model, etc., that responds to natural-language prompts in natural language), generative image model (e.g., that responds to natural-language prompts with an image), generative video model (e.g., that responds to natural-language prompts with a video), generative coding model (e.g., that responds to natural-language prompts with software code), or the like. As used herein, the term “natural language” or “natural-language” refers to language, including grammar, that would be expected in a normal conversation between two humans. A pre-trained generative AI model may be used as a base model that is fine-tuned for the specific task of AI agent 160, to produce AI model 162.

One well-known example of a large language model is the Generative Pre-trained Transformer (GPT). GPT-4 is the fourth-generation language prediction model in the GPT-n series, created by OpenAI of San Francisco, California. GPT-4 is an autoregressive language model that uses deep learning to produce human-like text. GPT-4 has been pre-trained on a vast amount of text from the open Internet. While GPT-4 is provided as an example, it should be understood that the generative language model may be any generative language model, including past and future generations of GPT, as well as other large language models, such as any of the DeepSeek family of large language models from DeepSeek AI of Hangzhou, Zhejiang, China, any of the Claude family of large language models (e.g., Claude Opus, Claude Sonnet, etc.) developed by Anthropic PBC of San Francisco, California, the Falcon large language model (e.g., Falcon 160B) released by the United Arab Emirates' Technology Innovation Institute (TII), the Large Language Model Meta AI (LLaMA) model (e.g., LLaMA 2) released by Meta AI of New York, New York, any of the Gemini family of large language models from Google LLC of Mountain View, California, any of the Mistral family of models released by Mistral AI of Paris, France, and the like.

Examples of generative image models include, without limitation, the DALL-E family of models (e.g., DALL-E, DALL-E 2, or DALL-E 3) from OpenAI, Stable Diffusion (e.g., SD 3.5) from Stability AI Ltd of London, England, United Kingdom, Imagen (e.g., Imagen 3) from Google LLC of Mountain View, California, Midjourney form Midjourney, Inc. of San Francisco, California, Adobe Firefly from Adobe Inc. of San Jose, California, Picasso from Nvidia Corp. of Santa Clara, California, Runway Gen-2 from Runway AI, Inc. of New York City, New York, and the like. Examples of generative video models include, without limitation, Runway Gen-2, the Pika family of models from Pika Labs AI of San Francisco, California, Lumiere from Google LLC, VideoLDM from Nvidia, Make-A-Video from Meta Platforms, Inc. of Menlo Park, California, Synthesia from Synthesia of London, England, United Kingdom, DeepBrain AI from AI Studios of Palo Alto, California, Stable Video Diffusion from Stability AI Ltd, and the like.

Examples of generative coding models include, without limitation, Codex from OpenAI, AlphaCode from Google LLC, Code LLaMA from Meta AI, AlphaFold Code from DeepMind Technologies Limited of London, England, United Kingdom, CodeWhisperer from Amazon Web Services of Seattle, Washington, CodeGen from Salesforce, Inc. of San Francisco, California, StarCoder developed by Hugging Face and ServiceNow Research, Tabnine from Tabnine of Tel Aviv, Israel, and the like.

Each AI agent 160 may comprise or be communicatively coupled to zero, one, or a plurality of tools 164. Tool(s) 164 may be hosted within computing environment 150 (e.g., a cloud-computing environment) and/or externally to computing environment 150 (e.g., on a third-party system 140). AI agent 160 may communicate with a tool 164 via an application programming interface 163 of that tool 164. Application programming interface 163, which may be a WebAPI, software development kit (SDK), or other set of callable functions, may provide one or more operations that can be performed by AI agent 160 using the respective tool 164. Each operation may accept zero, one, or a plurality of parameters as input and/or return an output that comprises data representing a response, an acknowledgement, and/or the like. An operation, which may also be referred to as an “endpoint,” may be defined by a base Uniform Resource Locator (URL), a path that indicates the resource or action being requested, an HTTP method defining the action to be performed (e.g., GET, POST, PUT, DELETE, etc.), zero, one, or more request parameters, a response format, an authentication or security protocol, a version number, rate limits, error handling, and/or the like.

Tools 164 enable an AI agent 160 to interact with external systems, and even potentially, the physical world. Each tool 164 may perform a sub-task for the overall task of AI application 160. A sub-task may comprise retrieving data from a source (e.g., another software entity, a local database hosted within computing environment 150, a remote database hosted externally to computing environment 150, a third-party system, application, or database, an integration process, a knowledge base, etc.), transforming, formatting, mapping, cleaning, or otherwise manipulating data, analyzing data, storing data, sending data (e.g., tabular or other structured data, unstructured data, commands, requests, queries, etc.) to a destination (e.g., another software entity, a local database, a remote database, a third-party system, application, or database, an integration process, knowledge base, etc.), initiating a transaction (e.g., purchase, sale, exchange, trade, etc.), completing a transaction, actuating a physical device (e.g., activating a motor, switch, or other machine component, setting or adjusting a setpoint for a control parameter, etc.), and/or the like.

An AI agent 160 may interact with user systems 130 and/or third-party systems 160, as well as software entities within computing environment 150, including other AI agents 160, via an agentic interface 165. Agentic interface 165 may comprise an application programming interface to be used by other software entities and/or a user interface for interaction with user systems 130. AI agent 160 may be a conversational agent, in which case agentic interface 165 may implement a user interface, which may comprise a graphical user interface (e.g., a chat frame into which a user types inputs and AI agent 160 outputs responses), an audio interface (e.g., a speech-to-text engine that converts a user's speech to text for input to AI agent 160 and/or a text-to-speech engine that converts the responses of AI agent 160 to speech), or a combination of graphical and audio user interface (i.e., an audiovisual user interface). The user interface may be comprised within user interface 115. Alternatively, the user interface may be separate and distinct from user interface 115.

Each AI agent 160 comprises a “stack” of components. The stack of an AI agent 160 may comprise the internal logic or “core” of AI agent 160, the data utilized by AI agent 160, each AI model 162 utilized by AI agent 160, a model router utilized by AI agent 160, each tool 164 utilized by AI agent 160, other components of infrastructure 100 utilized by AI agent 160, and/or the like. Data (e.g., logs) and/or metadata may be collected in a data store (e.g., database 114) for each component in the stack or for some subset of components in the stack of each AI agent 160. These data and/or metadata may be provided by the component itself or by another provider entity to the data store. For example, data and/or metadata may be collected via an observability framework, such as OpenTelemetry (OTel), which is an open-source observability framework, managed by the Cloud Native Computing Foundation (CNCF). In an embodiment, these data and/or metadata or a subset of these data and/or metadata form the performance telemetry that is described elsewhere herein.

At least one of AI agents 160 may be a performing AI agent 160P. A performing AI agent 160P is any AI agent 160 that is currently executing. It should be understood that this execution may include performing AI agent 160P performing inference using an AI model 162. There may be any number of performing AI agents 160P, executing within computing environment 150, at any given time. These performing AI agents 160P may execute in parallel, and may be entirely independent from any other performing AI agent 160P or may depend on one or more other performing AI agents 160P, depending on the particular tasks being performed. Each performing AI agent 160P may engage in a session with an end client, which may be user or a software entity. A session may comprise one or a plurality of interactions between the user or software entity and the performing AI agent 160P, which may trigger inference(s) using one or more AI models 162 and/or interactions with one or more tools 164, by performing AI agent 160P. In general, a session-specific context will be maintained over an entire session, which will inform the inferences made during the session.

At least one of AI agents 160 may be a consumer AI agent 160C. A consumer AI agent 160C may be a performing AI agent 160P that utilizes at least one provider entity (e.g., for a sub-task), which may be a tool 164 or other AI agent 160. In other word, a consumer AI agent 160C is simply a performing AI agent 160P that must consume a service provided by another software entity. Thus, any description herein of performing AI agent 160P applies equally to consumer AI agent 160C, and vice versa.

In an embodiment, at least one of AI agents 160 is a scoring AI agent 160S. As will be discussed in greater detail elsewhere herein, scoring AI agent 160S may generate a score for performing AI agents 160, based on performance telemetry of the performing AI agents 160. The score for a performing AI agent 160P may represent a deviation between the actual performance of performing AI agent 160P and an expected performance of performing AI agent 160P. The expected performance of performing AI agent 160P may be modeled or otherwise derived from historical data 172. When the score represents a significant deviation, scoring AI agent 160S may modify one or more parameters in an adaptive governance policy 174, which governs operation of performing AI agent 160P. This modification, which may optimize (e.g., throttle) one or more performance parameters, may trigger a real-time change in the operation of performing AI agent 160, even while performing AI agent 160P is performing inference.

In an embodiment, at least one of AI agents 160 is a discriminator AI agent 160D and at least one of AI agents 160 is an estimator AI agent 160E. As will be discussed in greater detail elsewhere herein, discriminator AI agent 160D may receive prompts, prior to inference, and identify similar prompts in historical data 172. Estimator AI agent 160E may utilize metadata and/or data, associated with these similar prompts in historical data 172, to predict a cost of inference for the given prompt. This predicted cost can be used to inform automated, semi-automated, or manual decision-making, such as whether or not to perform the inference using the given prompt, modify the prompt, cancel the prompt, and/or the like.

It should be understood that scoring AI agent 160S, discriminator AI agent 160D, and estimator AI agent 160E may themselves be considered performing AI agents 160P and/or consumer AI agents 160C, when they are executing. Thus, any description herein of performing AI agent 160P and/or consumer AI agent 160C applies equally to scoring AI agent 160S, discriminator AI agent 160D, and estimator AI agent 160E. However, it is generally contemplated that scoring AI agent 160S, discriminator AI agent 160D, and/or estimator AI agent 160E would execute in the background to interact with performing AI agents 160P and/or consumer AI agents 160C, and/or data for performing AI agents 160P and/or consumer AI agents 160C.

As used herein, a reference numeral with an appended letter will be used to refer to a specific component, whereas the same reference numeral without any appended letter will be used to refer collectively to a plurality of the component or to refer to a generic or arbitrary instance of the component. Thus, for example, the term “AI agents 160” refers collectively to all AI agents 160, including performing AI agent 160P, consumer AI agent 160C, scoring AI agent 160S, discriminator AI agent 160D, and estimator AI agent 160E, and the term “AI agent 160” may refer to any single AI agent 160, including potentially performing AI agent 160P, consumer AI agent 160C, scoring AI agent 160S, discriminator AI agent 160D, or estimator AI agent 160E.

In any case in which an AI agent 160, such as performing AI agent 160P, consumer AI agent 160C, scoring AI agent 160S, discriminator AI agent 160D, or estimator AI agent 160E, is described as using an AI model 162 that is a generative model, such as a generative language model (e.g., large language model), AI agent 160 may generate an input to AI model 162 based on any of the relevant data available to AI agent 160. In particular, AI agent 160 may incorporate the relevant data into a predefined template to generate a prompt, which may comprise or consist of a natural-language expression. The predefined template may comprise a pre-conversation and/or post-conversation, which provide context and/or instructions for AI model 162, and one or more placeholders into which the relevant data are inserted. The pre-conversation and/or post-conversation may define the role of AI model 162 model (e.g., to respond to a prompt, query, request, or other input according to the relevant data and a current context, summarize the relevant data, generate image or video data or software code from the relevant data, perform an action, etc.), define an output format for AI model 162 (e.g., natural language, a table, a list structure, a hierarchical structure, a markup-language structure, etc.), and/or the like. The prompt is input to AI model 162 to produce a response from AI model 162 (e.g., in the output format defined by the prompt). This response is the output of AI model 162, which may then be utilized by AI agent 160, for example, as the response from AI agent 160, to select and/or configure a tool 164 or other AI agent 160, as input to a tool 164, as input to another AI agent 160, as relevant data for a further input to AI model 162, as input to another AI model 162, and/or the like.

In addition, any AI agent 160 described herein, including performing AI agent 160P, consumer AI agent 160C, scoring AI agent 160S, discriminator AI agent 160D, and/or estimator AI agent 160E, may utilize a retrieval-augmented (RAG) architecture. The RAG architecture combines a retrieval-based component, represented, for example, by tool(s) 164 or a direct query to database 114, with a generation-based component, represented, for example, by AI model 162, which may be a large language model, small language model, or other generative language model. In response to an input, the AI agent 160 may retrieve relevant data from a knowledge base (e.g., via tool 164), and then generate a response by applying the AI model 162 to the retrieved relevant data. The RAG architecture provides dynamic and scalable access to data, improved generalization (e.g., enabling AI model 162 to respond to prompts beyond those for which AI model 162 was trained), and reduced model size (e.g., since AI model 162 does not need to store all relevant data internally). Suitable enhancements to the RAG architecture, which may be used, include Chunked RAG (CRAG), in which the retrieval-based component retrieves relevant chunks of the performance data, and Self-RAG, in which the retrieval-based component is able to retrieve relevant data from a store of prior responses, as well as the knowledge base.

In an embodiment, one or more performing AI agents 160P may interact with a distributed ledger 180. In particular, performing AI agents 160P may write data to distributed ledger 180 and/or read data from distributed ledger 180. As is well known in the art, a distributed ledger 180 is a decentralized database that is replicated and synchronized across multiple nodes in a network. Each node maintains a copy of the ledger, and additions are recorded through a consensus mechanism that ensures accuracy and consistency. This design means that distributed ledger 180 is highly resistant to tampering, since any changes must be verified and agreed upon by the network, thereby ensuring a transparent record of data.

In an embodiment, distributed ledger 180 is a blockchain. A blockchain is a specific type of distributed ledger that organizes data into sequential blocks. Each block is cryptographically linked to the previous block, forming an unalterable chain of data blocks. Every block typically contains a set of data entries, a timestamp, and a unique cryptographic hash that secures the block against tampering. Since all nodes in the network share and validate the same chain through a consensus mechanism, the blockchain ensures transparency, immutability, and trust without the need for a central authority.

Unless otherwise defined, any of the data described herein, including data used by AI agents 160, data generated by AI agents 160, historical data 172, data stored in distributed ledger 180, and the like, may comprise any type of data, including structured data, semi-structured data, and unstructured data. Structured data refers to information that is organized into a fixed format (e.g., rows and columns), such that it is easy to search and analyze. Examples of structured data include, without limitation, relational databases, sensor data, Transmission Control Protocol (TCP)/Internet Protocol (IP) packets, and the like. Semi-structured data refers to information that does not have a rigid tabular format, but maintains some organizational markers (e.g., tags, hierarchies, etc.), which allows for partial structure and flexibility. Examples of semi-structured data include, without limitation, JavaScript Object Notation (JSON) objects, eXtensible Markup Language (XML) objects, email messages, and the like. Unstructured data refers to information without a fixed format or model, which is often difficult to categorize and analyze systematically. Examples of unstructured data include, without limitation, image files, video files, audio files, free-text documents, and the like.

### 2. Example Processing System

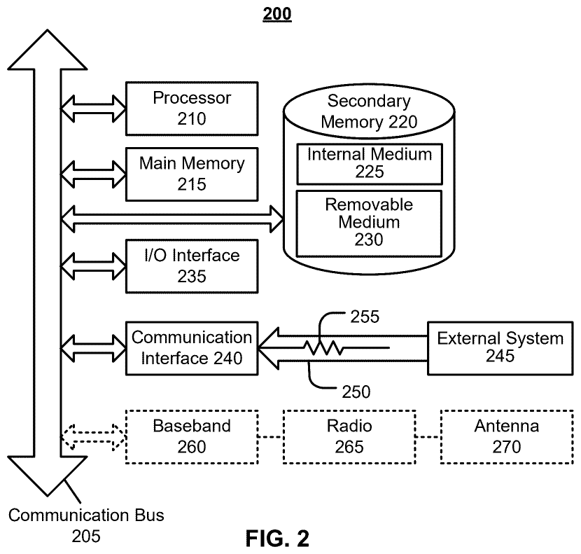

FIG. 2 illustrates an example processing system 200, by which one or more of the processes described herein may be executed, according to an embodiment. For example, system 200 may be used to store and/or execute server application 112, AI agent(s) 160, AI model(s) 162, tool(s) 164, and/or may represent components of platform 110, user system(s) 130, third-party system(s) 140, and/or other processing devices described herein. System 200 can be any processor-enabled device (e.g., server, personal computer, etc.) that is capable of wired or wireless data communication. Other processing systems and/or architectures may also be used, as will be clear to those skilled in the art.

System 200 may comprise one or more processors 210. Processor(s) 210 may comprise a central processing unit (CPU). Additional processors may be provided, such as a graphics processing unit (GPU), an auxiliary processor to manage input/output, an auxiliary processor to perform floating-point mathematical operations, a special-purpose microprocessor having an architecture suitable for fast execution of signal-processing algorithms (e.g., digital-signal processor), a subordinate processor (e.g., back-end processor), an additional microprocessor or controller for dual or multiple processor systems, and/or a coprocessor. Such auxiliary processors may be discrete processors or may be integrated with a main processor 210. Examples of processors which may be used with system 200 include, without limitation, any of the processors (e.g., Pentium™, Core i7™, Core i9™, Xeon™, etc.) available from Intel Corporation of Santa Clara, California, any of the processors available from Advanced Micro Devices, Incorporated (AMD) of Santa Clara, California, any of the processors (e.g., A series, M series, etc.) available from Apple Inc. of Cupertino, any of the processors (e.g., Exynos™) available from Samsung Electronics Co., Ltd., of Seoul, South Korea, any of the processors available from NXP Semiconductors N.V. of Eindhoven, Netherlands, any of the processors available from Nvidia Corporation of Santa Clara, California, and/or the like.

Processor(s) 210 may be connected to a communication bus 205. Communication bus 205 may include a data channel for facilitating information transfer between storage and other peripheral components of system 200. Furthermore, communication bus 205 may provide a set of signals used for communication with processor 210, including a data bus, address bus, and/or control bus (not shown). Communication bus 205 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPIB), IEEE 696/S-100, and/or the like.

System 200 may comprise main memory 215. Main memory 215 provides storage of instructions and data for programs executing on processor 210, such as any of the software discussed herein. It should be understood that programs stored in the memory and executed by processor 210 may be written and/or compiled according to any suitable language, including without limitation C/C++, Java, JavaScript, Perl, Python, Visual Basic, .NET, and the like. Main memory 215 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

System 200 may comprise secondary memory 220. Secondary memory 220 is a non-transitory computer-readable medium having computer-executable code and/or other data (e.g., any of the software disclosed herein) stored thereon. In this description, the term “computer-readable medium” is used to refer to any non-transitory computer-readable storage media used to provide computer-executable code and/or other data to or within system 200. The computer software stored on secondary memory 220 is read into main memory 215 for execution by processor 210. Secondary memory 220 may include, for example, semiconductor-based memory, such as programmable read-only memory (PROM), erasable programmable read-only memory (EPROM), electrically erasable read-only memory (EEPROM), and flash memory (block-oriented memory similar to EEPROM).

Secondary memory 220 may include an internal medium 225 and/or a removable medium 230. Internal medium 225 and removable medium 230 are read from and/or written to in any well-known manner. Internal medium 225 may comprise one or more hard disk drives, solid state drives, and/or the like. Removable storage medium 230 may be, for example, a magnetic tape drive, a compact disc (CD) drive, a digital versatile disc (DVD) drive, other optical drive, a flash memory drive, and/or the like.

System 200 may comprise an input/output (I/O) interface 235. I/O interface 235 provides an interface between one or more components of system 200 and one or more input and/or output devices. Examples of input devices include, without limitation, sensors, keyboards, touch screens or other touch-sensitive devices, cameras, biometric sensing devices, computer mice, trackballs, pen-based pointing devices, and/or the like. Examples of output devices include, without limitation, other processing systems, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and/or the like. In some cases, an input and output device may be combined, such as in the case of a touch-panel display (e.g., in a smartphone, tablet computer, or other mobile device).

System 200 may comprise a communication interface 240. Communication interface 240 allows software to be transferred between system 200 and external devices, networks, or other information sources. For example, computer-executable code and/or data may be transferred to system 200 from a network server via communication interface 240. Examples of communication interface 240 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing system 200 with a network (e.g., network(s) 120) or another computing device. Communication interface 240 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software transferred via communication interface 240 is generally in the form of electrical communication signals 255. These signals 255 may be provided to communication interface 240 via a communication channel 250 between communication interface 240 and an external system 245. In an embodiment, communication channel 250 may be a wired or wireless network (e.g., network(s) 120), or any variety of other communication links. Communication channel 250 carries signals 255 and can be implemented using a variety of wired or wireless communication means including wire or cable, fiber optics, conventional phone line, cellular phone link, wireless data communication link, radio frequency (“RF”) link, or infrared link, just to name a few.

Computer-executable code is stored in main memory 215 and/or secondary memory 220. Computer-executable code can also be received from an external system 245 via communication interface 240 and stored in main memory 215 and/or secondary memory 220. Such computer-executable code, when executed, enables system 200 to perform one or more of the various processes disclosed herein.

In an embodiment that is implemented using software, the software may be stored on a computer-readable medium and initially loaded into system 200 by way of removable medium 230, I/O interface 235, or communication interface 240. In such an embodiment, the software is loaded into system 200 in the form of electrical communication signals 255. The software, when executed by processor 210, may cause processor 210 to perform one or more of the various processes disclosed herein.

System 200 may optionally comprise wireless communication components that facilitate wireless communication over a voice network and/or a data network (e.g., in the case of user system 130). The wireless communication components comprise an antenna system 270, a radio system 265, and a baseband system 260. In system 200, radio frequency (RF) signals are transmitted and received over the air by antenna system 270 under the management of radio system 265.

In an embodiment, antenna system 270 may comprise one or more antennae and one or more multiplexors (not shown) that perform a switching function to provide antenna system 270 with transmit and receive signal paths. In the receive path, received RF signals can be coupled from a multiplexor to a low noise amplifier (not shown) that amplifies the received RF signal and sends the amplified signal to radio system 265.

In an alternative embodiment, radio system 265 may comprise one or more radios that are configured to communicate over various frequencies. In an embodiment, radio system 265 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 265 to baseband system 260.

If the received signal contains audio information, baseband system 260 decodes the signal and converts it to an analog signal. Then, the signal is amplified and sent to a speaker. Baseband system 260 also receives analog audio signals from a microphone. These analog audio signals are converted to digital signals and encoded by baseband system 260. Baseband system 260 also encodes the digital signals for transmission and generates a baseband transmit audio signal that is routed to the modulator portion of radio system 265. The modulator mixes the baseband transmit audio signal with an RF carrier signal, generating an RF transmit signal that is routed to antenna system 270 and may pass through a power amplifier (not shown). The power amplifier amplifies the RF transmit signal and routes it to antenna system 270, where the signal is switched to the antenna port for transmission.

Baseband system 260 may be communicatively coupled with processor(s) 210, which have access to memory 215 and 220. Thus, software can be received from baseband processor 260 and stored in main memory 210 or in secondary memory 220, or executed upon receipt. Such software, when executed, can enable system 200 to perform one or more of the various processes disclosed herein.

### 3. Performance Optimization

Latency during the execution of performing AI agents 160 can come from a number of sources, including model latency, tool latency, and communication latency. Model latency results from the use of an AI model 162, which may require time to generate an output from an input. Tool latency results from the use of a tool 164, which may require time to perform its designated sub-task (e.g., a deep database search, deep web search, etc.). Communication latency refers to transmission times, propagation delays, processing overhead, network congestion, hardware and infrastructure limitations, and the like, resulting from communication protocols. Relevant communication protocols include inter-agent communication protocols, such as Model Context Protocol (MCP), Agent Communication Protocol (ACP), Agent-to-Agent Protocol (A2A), Agent Network Protocol (ANP), and the like.

Latency may be measured by one or more performance metrics. For example, measures of model latency include, without limitation, time to first token (TTFT), time per output token (TPOT), and total generation time. Time to first token refers to the time duration between the time at which a generative language model receives a prompt and the time at which the generative language model outputs the first token of its response to the prompt. Time per output token refers to the average amount of time a generative language model takes to generate each subsequent token in the response, after the first token has been generated. Total generation time refers to the time duration between the time at which a generative AI model receives an input and the time at which the generative AI model outputs the final response to the input. While there are techniques for reducing model latency, such techniques are not dynamically adaptive. For example, model routers are not able to optimize the context pipelines from data, tools 164, functions, and inter-agent communications.

In an embodiment, scoring AI agent 160S is used to optimize the performance of performing AI agents 160P. This optimization may be in terms of computational time (e.g., model latency, tool latency, communication latency, etc.), resource utilization, or other cost. In this context, the term “cost” may refer to an economic cost (e.g., price for resource utilization), computational cost (e.g., computational time, resource utilization, etc.), energy cost (e.g., amount of energy consumed), ecological cost (e.g., amount of greenhouse gases emitted), incurred by the operation of performing AI agent 160P, which may include utilization of AI model(s) 162, tool(s) 164, and/or the like.

Scoring AI agent 160S may utilize adaptive governance policy 174 to dynamically and adaptively manage policies that are applied to performing AI agents 160P at inference time. The policies may be represented as one or more parameters, comprised within adaptive governance policy 174. The parameter(s) may represent values, ranges, limits, operating modes, and/or the like for resource utilization, latency, costs, and/or the like, during inference by performing AI agents 160P.

Adaptive governance policy 174 may comprise a plurality of parameters that are organized into a plurality of hierarchical levels. For example, values of the parameter(s) may be applied at the level of an individual performing AI agent 160P, group (e.g., a small plurality) of performing AI agents 160P, supergroup (e.g., a large plurality or a group of groups) of performing AI agents 160P, swarms (e.g., a very large plurality or a group of a very large number of groups) of performing AI agents 160P, all performing AI agents 160P for a particular user, all performing AI agents 160P for a particular organization, all performing AI agents 160P within computing environment 150, and/or the like. More generally, the plurality of hierarchical levels may comprise a first level that is specific to a particular performing AI agent 160P, and at least one second level that represents a group of two or more performing AI agents 160P. In this case, each performing AI agent 160P could be represented by a leaf node in the hierarchy, with the leaf node comprising a value for each of one or more parameters, and all of the ancestral nodes from the leaf node to the root node comprising a value for each of one or more parameters. In the event that the value of the same parameter is defined at two or more levels, the value for that parameter in the node that is closest to the leaf node may be used as the parameter value for the respective performing AI agent 160P. In other words, parameter values lower in the hierarchy (i.e., closer to the leaf node) may supersede parameter values that are higher in the hierarchy (i.e., closer to the root node).

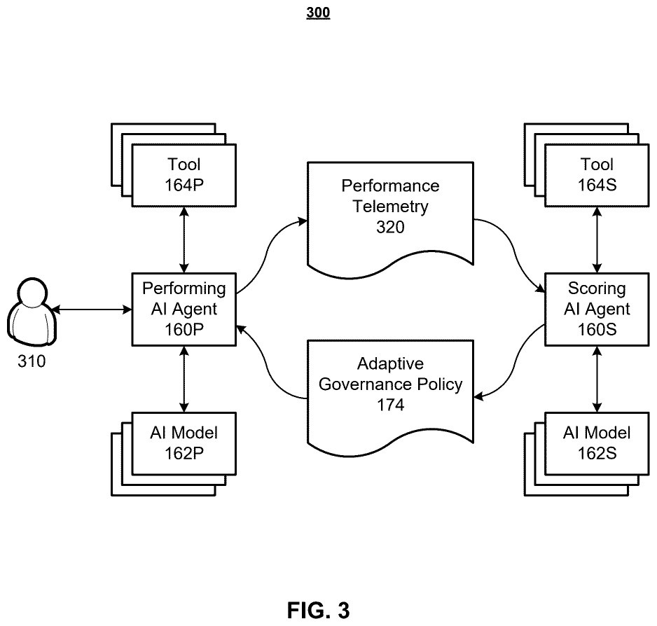

FIG. 3 illustrates an example data flow 300 for dynamic and adaptive optimization of AI agents 160 at inference time, according to an embodiment. It should be understood that data flow 300 is shown by way of example, rather than limitation, and that a myriad other arrangements of the data flow are possible. In addition, while only a single end client 310, a single performing AI agent 160P, and a single scoring AI agent 160S, a single performance telemetry 320, and a single adaptive governance policy 174, are illustrated, data flow 300 may comprise any number of end clients 310, performing AI agents 160P, scoring AI agents 160S, performance telemetries 320, and/or adaptive governance policies 174.

An end client 310 may interact with performing AI agent 160P, via agentic interface 165, to perform a task, within a session. End client 310 may be a user, interacting with AI agent 160P via a graphical user interface of agentic interface 165 rendered at user system 130. Alternatively, end client 310 may be another software entity, interacting with AI agent 160P via an application programming interface of agentic interface 165 from a third-party system 140. End client 310 may invoke AI agent 160P with an input, such as a prompt, query, request, instruction, or the like. In some cases, performing AI agent 160P may be a conversational AI agent that converses with end client 310 (e.g., a human user) using natural language. Each session between an end client 310 and performing AI agent 160P may be identified by a unique session identifier.

During execution, performance telemetry 320 may be generated and recorded for performing AI agent 160P. Performance telemetry 320 may comprise agent logs, agent metadata, tool logs, tool metadata, data-interaction logs, data-interaction metadata, inter-agent-communication logs, inter-agent-communication metadata, and/or the like. The agent log may comprise entries, representing the history of events, activities, messages, and/or the like, arising during execution of performing AI agent 160P, including the utilization of AI model(s) 162P. Similarly, the tool logs, data-interaction logs, and inter-agent-communication logs may comprise entries representing the history of events, activities, messages, and/or the like, arising during utilization of tools 164P, during data interactions, and during communications between performing AI agent 160P and other AI agents 160, respectively. The agent metadata, tool metadata, data-interaction metadata, and inter-agent-communication metadata may comprise information about performing AI agent 160P, tool(s) 164P, data interactions, and communications between performing AI agent 160P and other AI agents 160, respectively. This information may include costs (e.g., economic, computational, energy, ecological, etc.) incurred by execution of the component, one or more utilization metrics representing resource utilization by the component, one or more performance metrics representing performance of the component, and/or the like. Performance telemetry 320 may be associated with the session identifier for the session, such that the entire performance telemetry 320 for a given session, between end client 310 and performing AI agent 160P, can be easily retrieved.

Performance telemetry 320 may be generated and recorded by or for each of one or more components within the stack of performing AI agent 160P, including, for example, the core of performing AI agent 160P, AI model 162P, tool 164P, a model router utilized by performing AI agent 160P, an inter-agent communication protocol (e.g., MCP, ACP, A2A, ANP, etc.), and/or the like. Each of the component(s) may push data and/or metadata to a data store (e.g., database 114). Alternatively, another provider entity, such as an observability framework (e.g., OTel), could pull data and/or metadata from each component into the data store. As another alternative, one or more components may push data and/or metadata to the data store, while another provider entity pulls data and/or metadata from one or more other components into the data store. In any case, each of the data and/or metadata may be stored in association with the session identifier, such that the data and/or metadata may be easily and collectively retrieved as performance telemetry 320.

The utilization of components (e.g., core, AI model 162P, tool 164P, other AI agents 160, etc.) in the stack of performing AI agent 160P to generate a response to an input to performing AI agent 160P is referred to herein as an “inference.” At or by the time performing AI agent 160P is to perform an inference, performing AI agent 160P may receive the value of each of one or more parameters, representing one or more governance policies, from adaptive governance policy 174. Performing AI agent 160P may pull the value of each parameter from adaptive governance policy 174. Alternatively or additionally, updates to the values of any parameter in adaptive governance policy 174 may be pushed to performing AI agent 160P. In an embodiment, the value of a parameter may be pulled by or pushed to the specific component to which the parameter pertains. For instance, the values of parameters that affect the configuration of performing AI agent 160P may be directly received and applied by the core of performing AI agent 160P, the values of parameters that affect the configuration of AI model 162P may be directly received and applied by AI model 162P or an applicable model router, the values of parameters that affect the configuration of tool 164P may be directly received and applied by tool 164P, the values of parameters that affect the configuration of an inter-agent communication protocol may be directly received and applied by infrastructure components of the inter-agent communication protocol, and so on and so forth.

Adaptive governance policy 174 may store a governance policy at an agent level, agentic group level, agentic supergroup level, agentic swarm level, user level, organization level, environment level, and/or the like. Each governance policy may be defined by a value for each of a set of one or more parameters. In an embodiment, adaptive governance policy 174 may store a hierarchical set of governance policies comprising two or more levels, with the values of one set of parameters defined for a lower level, and the values of another set of parameters and/or alternative (e.g., default) values of the same set of parameters defined for a higher level. A governance policy, as defined by the value(s) for a set of parameter(s), may govern the configuration (e.g., one or more variables) of performing AI agent 160P during inference, the configuration of an AI model 162P, the configuration of a tool 164P, the configuration of an inter-agent communication protocol, one or more attributes of an input to an AI model 162P, one or more attributes of an input to a tool 164P, resource utilization during inference (e.g., which and/or what amount of resource(s) are utilized for the inference), one or more constraints on the execution of performing AI agent 160P, AI model 162P, tool 164P, an applicable inter-agent communication protocol, other resources, and/or the like. The parameter(s) that are used to define a governance policy may comprise a parameter of the data used by performing AI agent 160P, a parameter of one or more AI models 162P used by performing AI agent 160P, a parameter of one or more tools 164P used by performing AI agent 160P, a parameter of one or more other AI agents 160P used by performing AI agent 160P, a parameter of a model router or other router used by performing AI agent 160P, a parameter of an inter-agent communication protocol used by performing AI agent 160P, and/or the like.

Performing AI agent 160P may adjust its operation, according to the value(s) of the parameter(s), representing a governance policy, before or while performing inference. Alternatively, another software entity (e.g., scoring AI agent 160S, server application, another AI agent 160, etc.) may adjust the operation of performing AI agent 160P. This adjustment may comprise changing a configuration of performing AI agent 160P, changing a configuration of one or more AI models 162P and/or a model router, modifying a prompt for an AI model 162P, changing the configuration of one or more tools 164P, changing the configuration of an inter-agent communication protocol utilized by performing AI agent 160P to communicate with other AI agents 160, changing the configuration of one or more other AI agents 160 that are utilized by performing AI agent 160P, and/or the like. In other words, performing AI agent 160P may perform the inference according to the governance policy defined by the received value(s) of the parameter(s). When the adjustment occurs while performing AI agent 160P is in the midst of performing an inference, the inference may be updated according to the modified governance policy.

For as long as performing AI agent 160P is executing, scoring AI agent 160S may monitor the performance telemetry 320 being generated and recorded for performing AI agent 160P. In other words, scoring AI agent 160S may operate in parallel to performing AI agent 160P to monitor the performance of performing AI agent 160P. Scoring AI agent 160S may monitor a single performing AI agent 160P or a plurality of performing AI agents 160P, in this manner.

The objective of scoring AI agent 160S is to dynamically assess a variance or deviation in the performance of performing AI agent 160P, in terms of performance metrics, derived from performance telemetry 320 and representing resource utilization and/or other costs, and optimize one or more parameters in adaptive governance policy 174, which affect the performance of AI agent 160P, to reduce, eliminate, or otherwise mitigate any detected deviation. In general, it is contemplated that this optimization may comprise throttling one or more resources utilized by performing AI agent 160P, such as AI model 162P, tool 164P, one or more computational resources utilized by the core of performing AI agent 160P, and/or the like.

To this end, scoring AI agent 160S may automatically receive performance telemetry 320 for performing AI agent 160P, analyze performance telemetry 320, and update the value of each of one or more parameters in adaptive governance policy 174 based on the analysis of performance telemetry 320. The analysis and the update of parameter values may be performed in any suitable manner. For example, scoring AI agent 160S may utilize one or more AI models 162S and/or tools 164S to analyze performance telemetry 320 and produce the updated parameter value(s) for one or more levels of governance policies. In general, scoring AI agent 160S may compare the actual value of one or more performance metrics, comprised in or derived from performance telemetry 320, to the expected value of each of those performance metric(s), and determine whether or not an adjustment needs to be made to adaptive governance policy 174, based on the deviation of the actual values from the expected values of the performance metric(s). The expected value of a performance metric may be derived from, or otherwise determined based on, historical data 172, which may comprise historical performance metrics for the same performing AI agent 160P or similar AI agents 160. Essentially, scoring AI agent 160S compares the behavioral pattern of performing AI agent 160P to an expected behavioral pattern to determine whether or not performing AI agent 160P is behaving normally or abnormally, and when detecting abnormal behavior, triggers a change in operation of performing AI agent 160P, via adaptive governance policy 174. This may all be done in real time, during operation of performing AI agent 160P.

As an example, scoring AI agent 160S may generate a prompt, comprising relevant data derived from performance telemetry 320, a representation of an expected performance of performing AI agent 160P (e.g., expected value of each of one or more performance metrics) derived from historical data 172, and an instruction to determine the value of one or more parameters based on the relevant data and expected performance. In this case, the prompt may be input to AI model 162S to produce an output, and the parameter value(s) in adaptive governance policy 174 may be updated according to the output of AI model 162S.

As another example, scoring AI agent 160S may utilize a statistical method (e.g., regression) for the analysis. This statistical method may be embodied in AI model 162S or the core (i.e., internal logic) of scoring AI agent 160S. The statistical method may detect anomalies or unexpected deviations from a mean behavior or performance of performing AI agent 160P, as embodied, for example, in one or more performance metrics at one or more levels of the stack of performing AI agent 160P and/or across two or more levels of the stack of performing AI agent 160P.

As another example, scoring AI agent 160S may utilize rule-based logic to deterministically produce the updated parameter value(s), in adaptive governance policy 174, from performance telemetry 320. For instance, the value of one or more performance metrics, extracted or otherwise derived from performance telemetry 320, and the expected value of each of the performance metric(s) may be input into an algorithm that computes the magnitude of deviation(s), compares the magnitude of deviations to one or more thresholds, and sets the value of one or more parameters in adaptive governance policy 174 based on the comparison. In this case, the algorithm may weight one or more performance metrics higher than one or more other performance metrics, depending on their relative importance to the overall computation.

Regardless of the particular analytic technique, scoring AI agent 160S may update the value of each of one or more parameters in adaptive governance policy 174, based on the analysis. For example, parameter value(s) may be updated based on the deviation (e.g., magnitude of deviation) between the actual performance and expected performance of performing AI agent 160P. Scoring AI agent 160S may interact with adaptive governance policy 174 as a tool 164S, in which case, scoring AI agent 160S may set the value of each parameter in adaptive governance policy 174, via an endpoint of an application programming interface 163 of tool 164S. An update to the value of any parameter that affects or pertains to performing AI agent 160P may trigger a communication to performing AI agent 160P, and potentially to the specific component, within the stack of performing AI agent 160P, that is affected by the update. In this manner, the operation of performing AI agent 160P may be modified in real time, even as inference is being performed.

As illustrated, a feedback loop may exist between performing AI agent 160P and scoring AI agent 160S. In particular, performing AI agent 160P produces performance telemetry 320. Scoring AI agent 160S analyzes performance telemetry and updates adaptive governance policy 174, based on the analysis. These updates to adaptive governance policy 174 trigger changes to the operation of performing AI agent 160P. Performing AI agent 160P may produce new performance telemetry 320, according to this changed operation. This cycle may repeat for as long as performing AI agent 160P and scoring AI agent 160S are both operational, which may be during an entire session between end client 310 and performing AI agent 160P.

In an embodiment, an event-driven architecture (EDA) may be used for communicating performance telemetry 320 to scoring AI agent 160S and/or communicating updates in parameter values to performing AI agent 160P. The event-driven architecture may utilize a publish-and-subscribe (Pub-Sub) system, in which provider entities publish data to broker entities that package the data into a stream or topic that is consumed by consumer entities. In this case, performing AI agent 160P and/or individual components of its stack may act as provider entities that publish performance telemetry 320 to a stream, and scoring AI agent 160S may act as a consumer entity that subscribes to the stream of performance telemetry 320. In this case, scoring AI agent 160S may subscribe to a stream of performance telemetry 320 for each of a plurality of performing AI agents 160P under its supervision. Additionally or alternatively, scoring AI agent 160S may act as a provider entity to publish updates to adaptive governance policy 174, and performing AI agent 160P and/or individual components of its stack may act as consumer entities that subscribe to adaptive governance policy 174. Advantageously, a Pub-Sub system allows for asynchronous communications between provider and consumer entities.

In an alternative embodiment, other communication architectures may be used to collect data from AI agents 160 and provide data to AI agents 160. For example, periodically or in response to some trigger, performing AI agent 160P and/or individual components in the stack of performing AI agent 160P could transmit performance telemetry 320 directly to scoring AI agent 160S, or scoring AI agent 160S could retrieve performance telemetry 320 directly from performing AI agent 160P and/or individual components in the stack of performing AI agent 160P. Alternatively, periodically or in response to some trigger, performing AI agent 160P and/or individual components in the stack of performing AI agent 160P could transmit performance telemetry 320 to an intermediary, and scoring AI agent 160S could retrieve performance telemetry 320 from the intermediary. Similarly, in response to scoring AI agent 160S determining that a modification to adaptive governance policy 174 should occur, scoring AI agent 160S could transmit updated values of parameters of the adaptive governance policy 174 to performing AI agent 160P and/or individual components in the stack of performing AI agent 160P, either directly, or indirectly via an intermediary.

Regardless of the particular communication architecture that is employed, scoring AI agent 160S essentially monitors and adjusts the operation of performing AI agent 160P in real time. As used herein, the term “real-time” or “real time” refers to events that occur simultaneously as well as those that are separated in time by ordinary latencies in processing, memory access, communications (e.g., using a Pub-Sub system), and/or the like, and includes events that occur in what is commonly referred to as “near-real time.”

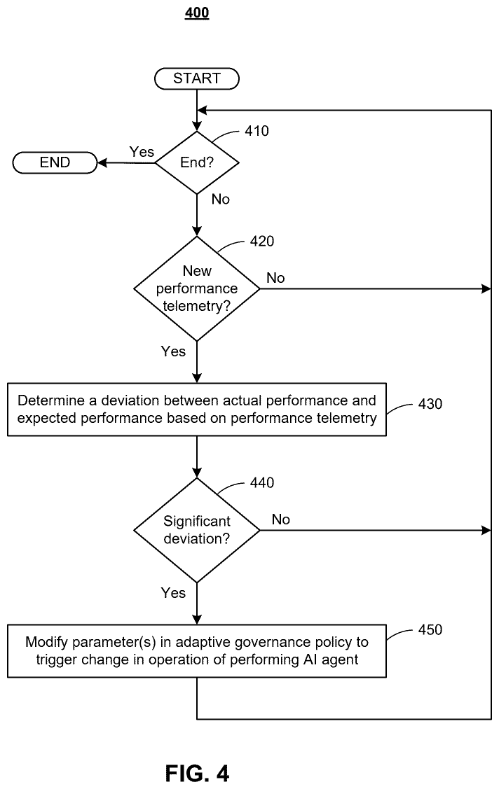

FIG. 4 illustrates an example process 400 for dynamic and adaptive optimization of AI agents 160 at inference time, according to an embodiment. Process 400 may be implemented by scoring AI agent 160S. Process 400 may be performed for each session between an end client 310 and a performing AI agent 160P, and particularly, may be performed while performing AI agent 160P is performing inference using at least one AI model 162P, and potentially one or more tools 164P and/or other components of the stack of performing AI agent 160P.

While process 400 is illustrated with a certain arrangement and ordering of subprocesses, process 400 may be implemented with fewer, more, or different subprocesses and a different arrangement and/or ordering of subprocesses. Furthermore, any subprocess, which does not depend on the completion of another subprocess, may be executed before, after, or in parallel with that other independent subprocess, even if the subprocesses are described or illustrated in a particular order.

Subprocess 410 may determine whether or not to end process 400. Process 400 may continue for as long as the implementing scoring AI agent 160S is operational. Process 400 may end when the execution of scoring AI agent 160S is terminated. However, it should be understood that there may be a plurality of scoring AI agents 160S operating independently from each other at any given time. When determining to end (i.e., “Yes” in subprocess 410), process 400 may end. Otherwise, when not determining to end (i.e., “No” in subprocess 410), process 400 may proceed to subprocess 420.

Subprocess 420 may determine whether or not new performance telemetry 320 has been received. For example, performance telemetry 320 may be pushed to scoring AI agent 160S by performing AI agent 160, including potentially by individual components of the stack of performing AI agent 160, or by an intermediary, such as a Pub-Sub system or other event-driven architecture (e.g., as a stream of performance telemetry 320 to which scoring AI agent 160S is subscribed). Alternatively, performance telemetry 320 may be pulled by scoring AI agent 160S directly from performing AI agent 160, including potentially from individual components of the stack of performing AI agent 160, or from an intermediary, such as a data store, periodically or in response to a trigger. In any case, scoring AI agent 160S receives performance telemetry 320 for performing AI agent 160P. Performance telemetry 320 may comprise agent logs, agent metadata, tool logs, tool metadata, data-interaction logs, data-interaction metadata, inter-agent-communication logs, inter-agent-communication metadata, and/or the like. More generally, performance telemetry 320 may comprise one or both of a log or metadata for each of one or more components in a stack of performing AI agent 160P, and preferably, for a plurality of components comprising two or more of a core of performing AI agent 160P, AI model 162P, a model router utilized by performing AI agent 160P, a tool 164P utilized by performing AI agent 160P, or an inter-agent communication protocol utilized by performing AI agent 160P to communicate with other AI agents 160. When new performance telemetry 320 is received (i.e., “Yes” in subprocess 420), process 400 may proceed to subprocess 430. Otherwise, while no new performance telemetry 320 is received (i.e., “No” in subprocess 420), process 400 may return to subprocess 410.

Subprocess 430 may determine a deviation between the actual performance of performing AI agent 160P and the expected performance of performing AI agent 160P, based on performance telemetry 320, and optionally historical performance telemetry from historical data 172. In an embodiment, a score may be generated to represent the overall deviation. As discussed elsewhere herein, this score may be determined using one or more AI models 162S, one or more tools 164S, a statistical method, a rule-based method, and/or the like, or derived from the output of one or more AI models 162S, one or more tools 164S, a statistical method, a rule-based method, and/or the like. The score may either represent a degree of deviant or abnormal behavior, with higher scores representing higher degrees of deviation than lower scores, or a degree of normal behavior, with lower scores representing higher degrees of deviation than higher scores. Conceptually, the score may represent how much the actual value(s) of one or more performance metrics, derived from performance telemetry 320, deviate from the expected value(s) of those performance metric(s). For a plurality of performance metrics, the deviations for each performance metric may be aggregated into a single score, in any suitable manner. For example, the deviations may be normalized to a single numerical scale and an average of the deviations may be computed as the score, potentially with the deviations for some performance metrics weighted higher than the deviations for other performance metrics during the averaging (i.e., a weighted average).

Subprocess 440 may determine whether or not the deviation, determined in subprocess 430, is significant. The deviation may be determined to be significant when the magnitude of the deviation satisfies (e.g., is greater than or equal to) a threshold. Conversely, the deviation may be determined to be insignificant when the magnitude of the deviation does not satisfy (e.g., is less than) the threshold. As discussed above, this deviation may be embodied in a score, which may be compared to a threshold. In the event that the score represents deviant or abnormal behavior, the score may satisfy the threshold when the score is greater than or equal to the threshold. Conversely, in the event that the score represents normal behavior, the score may satisfy the threshold when the score is less than the threshold. When determining that the deviation is significant (i.e., “Yes” in subprocess 440), process 400 may proceed to subprocess 450. Otherwise, when not determining that the deviation is significant (i.e., “No” in subprocess 440), process 400 may return to subprocess 410.

Subprocess 450 may modify the value of each of one or more parameters in adaptive governance policy 174. Adaptive governance policy 174 governs operation of performing AI agent 160P. Thus, the modification of the value of each of the parameter(s) may trigger a change in operation of performing AI agent 160P, even while performing AI agent 160P is performing an inference. The parameter values may be modified at one or more levels, including the level of performing AI agent 160P, the level of a group of AI agents 160 that includes performing AI agent 160P, the level of a supergroup of AI agents 160 that includes performing AI agent 160P, the level of a swarm of AI agents 160 that includes performing AI agent 160P, the level of the user account of end client 310, the level of an organizational account that includes the user account of end client 310, a global level (e.g., the level of the entire computing environment 150), and/or the like. More generally, adaptive governance policy 174 may comprise a plurality of parameters that are organized into a plurality of hierarchical levels that comprise at least a first level that is specific to each performing AI agent 160P and at least one second level that represents a group of two or more performing AI agents 160P.

Some concrete examples of parameters whose values may be modified at one or more levels include, without limitation, whether or not only quantized AI models may be used (e.g., expressed as a binary value), the alpha of a bypassing technique, the maximum time to first token (e.g., expressed in milliseconds), the time per output token (e.g., expressed in milliseconds), the maximum number of other AI agents 160 that may be utilized during inference (e.g., expressed as an integer), the timeout for inter-agent communications (e.g., expressed in milliseconds), the maximum total generation time (e.g., expressed in milliseconds), whether or not deep search is restricted (e.g., expressed as a binary value), the maximum number of tokens (e.g., expressed as an integer), and the like. The value for a parameter may be modified by increasing or decreasing the value (e.g., in the case of a numerical parameter value), toggling the value (e.g., in the case of a binary parameter value), switching to a different value among a set of possible predefined finite values (e.g., in the case of an enumerated parameter value), resetting the value to a default or other predefined value, and/or the like.

Adaptive governance policy 174 is a data object comprising parameterized variables whose values can be dynamically adjusted. While it is contemplated that adaptive governance policy 174 would primarily be modified by scoring AI agent(s) 160S, it should be understood that adaptive governance policy 174 could be modified by other sources as well. For example, one or more parameter values in adaptive governance policy 174 could be modified by another software entity (e.g., server application), by a user (e.g., administrative user), and/or the like, based on any variety of factors.

Whenever a parameter value, which pertains to a given performing AI agent 160P, is modified in adaptive governance policy 174, a change in operation of that performing AI agent 160P may be triggered in real time. For example, adaptive governance policy 174 may be managed by a software entity, such as a tool 164S, which may, in response to the modification of one or more parameter values that pertain to performing AI agent 160P, programmatically call the application programming interface of any affected component in the stack of performing AI agent 160P, to change the value of one or more configurable parameters of the affect component(s). Triggering the change in operation of performing AI agent 160P may comprise communicating directly (e.g., directly by the software entity that manages adaptive governance policy 174, which may be scoring AI agent 160S, a tool 164S, server application 112, another AI agent 160, etc.) or indirectly (e.g., by performing AI agent 160P itself or other intermediary) with one or more of the plurality of components in the stack of performing AI agent 160P. In summary, when a change in operation is triggered, one or more configurable parameters of each of one or more components, including potentially a plurality of components, in the stack of performing AI agent 160P may be adjusted. Again, the components that may be reconfigured in this manner may comprise two or more of a core of performing AI agent 160P, AI model 162P, a model router utilized by performing AI agent 160P, a tool 164P utilized by performing AI agent 160P, or an inter-agent communication protocol utilized by performing AI agent 160P to communicate with other AI agents 160.

In many cases, the change in operation of performing AI agent 160P may comprise throttling down (i.e., reducing or limiting) the utilization of one or more resources by performing AI agent 160P. In particular, when scoring AI agent 160S detects abnormal behavior, scoring AI agent 160S may throttle down the operation of performing AI agent 160P, via modification of adaptive governance policy 174, to prevent the waste of economic resources (e.g., by preventing unnecessary costs), computational resources (e.g., processing resources, memory resources, data storage resources, communication resources, etc.), energy resources (e.g., preventing brownouts), ecological resources (e.g., preventing the unnecessary emission of greenhouse gases), and/or the like. For example, this throttling down could place limits on resource utilization or other parameters that constrain any further inference (e.g., deep searching) by performing AI agent 160P, could prevent further inference by performing AI agent 160P entirely, and/or the like. In some cases, the throttling down of performing AI agent 160P may comprise terminating or suspending the execution of performing AI agent 160P altogether and/or terminating or suspending the execution of each of one or more components (e.g., AI model 162P, tool 164P, etc.) in the stack of performing AI agent 160P.

However, the change in operation of performing AI agent 160P may also comprise throttling up (i.e., increasing or unlimiting) the utilization of one or more resources by performing AI agent 160P. For example, when scoring AI agent 160S detects a return to normal behavior, after a prior incident of abnormal behavior, scoring AI agent 160S may throttle up the operation of performing AI agent 160P, via modification of adaptive governance policy 174. In this manner, performing AI agent 160P may be allowed to recover from deviant or abnormal operation. In some cases, throttling up the operation of performing AI agent 160P may require permission (e.g., for the allocation of additional resources). In this case, the permission may be obtained from end client 310 before throttling up the operation of performing AI agent 160P.

Changes in the operation of performing AI agent 160P may be directly or indirectly notified to end client 310. For example, a change in the configuration of a component in the stack of performing AI agent 160P may be directly notified to end client 310 (e.g., via a graphical user interface of agentic interface 165 if end client 310 is a user, or an application programming interface of agentic interface 165 if end client 310 is a software entity). Additionally or alternatively, a change may be indirectly notified to end client 310 (e.g., via a graphical user interface of agentic interface 165 if end client 310 is a user, or an application programming interface of agentic interface 165 if end client 310 is a software entity) when a component of performing AI agent 160P reaches a limit or is otherwise constrained by the value of a configurable parameter that was changed by a modification in adaptive governance policy 174. For instance, adaptive governance policy 174 may be modified by scoring AI agent 160S to reduce the maximum number of tokens that can be used with AI model 162P, in order to toggle down performing AI agent 160P. In this case, end client 310 may be notified when the maximum number of tokens is reached.

In an embodiment, all modifications to adaptive governance policy 174 are recorded (e.g., in database 114, historical data 172, distributed ledger 180, etc.). These modifications may be recorded as a time series for subsequent review and/or analysis. These time series may be used for refinement (e.g., retraining or fine-tuning) of performing AI agent 160P, refinement (e.g., retraining or fine-tuning) of scoring AI agent 160S, and/or the like. For instance, the recorded modifications may be used as historical data 172 to aid scoring AI agent 160S in future scoring of the behaviors of performing AI agents 160P.

### 4. Cost Prediction

Token-based communication can be costly in terms of computational resources, economic resources, energy resources, ecological resources, and/or the like. Downloadable, locally executed AI models 162 may not necessarily incur a token-based or other economic cost, but will still incur costs in terms of computational resources, energy consumption, ecological resources, and the like.

Tokens are the base unit of exchange between an end client 310 and a generative AI model, such as a generative language model (e.g., large language model, small language model, etc.). A token is a unit representation of a single word, plurality of words, sub-word (e.g., one or more characters that themselves do not form a complete word, but may form a prefix, suffix, or the like), pixel, unit of bits, or the like. The cost per token of using an AI model 162, such as a generative AI model, varies and depends on the particular AI model 162 being used.

Some model providers, such as OpenAI, Anthropic, and the like, charge users per token. However, costs for executing token-based AI models 162, such as large language models, are currently elusive. Costs are relatively straightforward to estimate when communication is conducted directly between end client 310 and AI model 162. However, with the interposition, between end client 310 and AI model 162, of AI agents 160, which may employ deep searches, multiple calls to one or more AI models 162, and/or utilization of other AI agents 160, the overall model utilization becomes much more complex and less transparent. This makes the costs much more difficult to estimate—let alone, predict.

Tools have been developed that can track the cost of using a token-based AI model 162 by the amount of tokens used. However, these tools can only estimate the costs after the tokens have already been used (i.e., after the costs have already been incurred). In addition, while model routers with embedded mechanistic interpretability, such as those provided by Martian Learning, Inc. of San Francisco, California, are able to identify the best model for each prompt by balancing model performance and model cost for the prompt, model routers cannot estimate the full cost of an agentic search, including the total token usage, prior to the execution of that search. Simply put, the state of the art provides no way to predict the full cost of a complete agentic task.

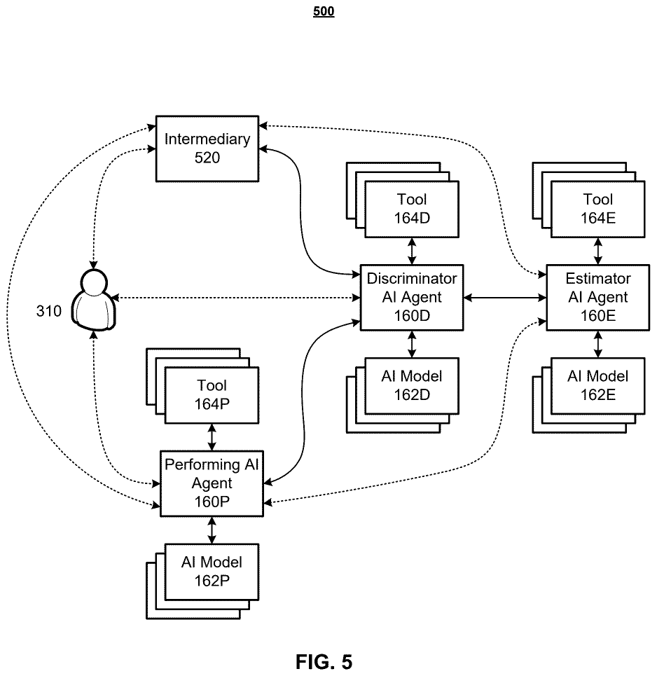

FIG. 5 illustrates an example data flow 500 for dynamic and adaptive prediction of inference costs prior to the utilization of AI models 162, according to an embodiment. The AI model(s) 162, which may comprise or consist of AI model 162P, may be token-based generative model(s), such as a large language model. It should be understood that data flow 500 is shown by way of example, rather than limitation, and that a myriad other arrangements of the data flow are possible. In addition, while only a single end client 310, a single intermediary 520, a single performing AI agent 160P, a single discriminator AI agent 160D, and a single estimator AI agent 160E are illustrated, data flow 500 may comprise any number of end clients 310, intermediaries 520, performing AI agents 160P, discriminator AI agents 160D, and/or estimator AI agents 160E.

A number of arrangements are possible for data flow 500, depending on the desired implementation. In a first arrangement, end client 310 interacts directly with discriminator AI agent 160D, which interacts directly with estimator AI agent 160E. In a second arrangement, end client 310 interacts directly with performing AI agent 160P, and performing AI agent 160P interacts directly with discriminator AI agent 160D, which interacts directly with estimator AI agent 160E. In a third arrangement, end client 310 interacts with performing AI agent 160P, and performing AI agent 160P interacts directly with both discriminator AI agent 160D and estimator AI agent 160E. In a fourth arrangement, end client 310 interacts directly with intermediary 520, intermediary 520 interacts directly with discriminator AI agent 160D, which interacts directly with estimator AI agent 160E, and intermediary 520 interacts directly with performing AI agent 160P. In a fifth arrangement, end client 310 interacts directly with intermediary 520, intermediary 520 interacts directly with both discriminator AI agent 160D and estimator AI agent 160E, and intermediary 520 interacts directly with performing AI agent 160P. There could also be a sixth arrangement in which end client 310 interacts directly with both discriminatory AI agent 160D and estimator AI agent 160E. However, this sixth arrangement is generally not preferred, since it places the onus on end client 310, which may be a human user, to understand how to utilize discriminatory AI agent 160D and estimator AI agent 160E together, which increases the risk of mistakes.

In the first arrangement, end client 310 may interact with discriminator AI agent 160D, via agentic interface 165 of discriminator AI agent 160D, to predict the cost of an input, within a session, prior to submitting the input to performing AI agent 160P. End client 310 may be a user interacting with discriminator AI agent 160D via a graphical user interface of agentic interface 165 of discriminator AI agent 160D, rendered at user system 130. Alternatively, end client 310 may be another software entity interacting with discriminator AI agent 160D via an application programming interface of agentic interface 165 of discriminator AI agent 160D, from a third-party system 140. End client 310 may invoke discriminator AI agent 160D with an input (e.g., a prompt, query, request, instruction, etc.) that end client 310 intends to submit to a performing AI agent 160P, but for which end client 310 desires to obtain a predicted cost first. In some cases, discriminator AI agent 160D may be a conversational AI agent that converses with end client 310 (e.g., a human user) using natural language.

In the second and third arrangements, end client 310 may interact with performing AI agent 160P, via agentic interface 165 of performing AI agent 160P, to perform a task, within a session. End client 310 may be a user interacting with performing AI agent 160P via a graphical user interface of agentic interface 165 of performing AI agent 160P, rendered at user system 130. Alternatively, end client 310 may be another software entity, interacting with performing AI agent 160P, via an application programming interface of agentic interface 165 of performing AI agent 160P, from a third-party system 140. End client 310 may invoke performing AI agent 160P with an input, such as a prompt, query, request, instruction, or the like. In some cases, performing AI agent 160P may be a conversational AI agent that converses with end client 310 (e.g., a human user) using natural language.

In the fourth and fifth arrangements, end client 310 may interact with intermediary 520 to perform a task using performing AI agent 160P, within a session. End client 310 may be a user interacting with intermediary 520 via a graphical user interface of intermediary 520, rendered at user system 130. Alternatively, end client 310 may be another software entity interacting with intermediary 520 via an application programming interface of intermediary 520, from a third-party system 140. End client 310 may invoke intermediary 520 with an input, such as a prompt, query, request, instruction, or the like. Intermediary 520 may be any type of software entity, including potentially an AI agent 160, that is logically positioned between end client 310 and performing AI agent 160P and determines whether or not to submit an input, received from end client 310, to performing AI agent 160P, based on the predicted cost, generated by estimator AI agent 160E.

It is generally contemplated that AI model 162P is a token-based AI model, such as a generative AI model, and particularly, a generative language model, such as a large language model. In this case, the input will generally be a prompt, which may comprise or consist of a natural-language expression, including potentially, a prompt, query, question, request, instruction, or the like. Alternatively, in the case that end client 310 is a software entity, the prompt may be encoded in the language utilized by that software entity. Thus, examples of disclosed embodiments will primarily be described with respect to token-based prediction of costs. However, it should be understood that disclosed embodiments may be utilized with any type of AI model 162P, including AI models that do not utilize tokens. In these cases, the costs may be predicted using other utilization metrics, besides the number of tokens.

During a session, discriminator AI agent 160D will receive at least one input from end client 310. It should be understood that, over the entire session, discriminator AI agent 160P may receive a plurality of inputs from end client 310. In the first arrangement, the input(s) are received directly from end client 310. In the second and third arrangements, the input(s) are received from performing AI agent 160P, which may relay the input(s), from end client 310 to discriminator AI agent 160D, either in their raw form or with pre-processing. In the fourth and fifth arrangements, the input(s) are received from intermediary 520, which may relay the input(s), from end client 310 to discriminator AI agent 160D, either in their raw form or with pre-processing.

At a high level, discriminator AI agent 160D compares the current input, received from end client 310 either directly or via performing AI agent 160P or intermediary 520, to historical inputs, to identify matching historical inputs. In particular, discriminator AI agent 160D may utilize AI model(s) 162D and/or tool(s) 164D to search historical data 172, to thereby identify one or more input identifiers, which each identifies a historical input, represented within historical data 172, that is similar to the current input.

Discriminator AI agent 160D may utilize any suitable search technique to compare the current input with historical inputs. For example, the historical inputs may be stored in a vector database, within historical data 172. In this case, each historical input may be converted to an embedding vector. Each embedding vector comprises a vector of real numbers, with each real number representing a position of the input within a different dimension of the plurality of dimensions of the vector space. Each embedding vector will have a length equal to the number of dimensions within the vector space. In practice, the vector space may comprise a hundred or more dimensions. The embedding vectors for the historical inputs may be stored in the vector database of historical data 172. The vector database represents the entire universe of semantic meaning, and the position, defined by each embedding vector, represents a semantic meaning of the associated historical input within that universe. To search the vector database, the current input may be converted into an embedding vector, in the same manner as the historical inputs were converted into embedding vectors. This embedding vector, representing the current input, may then be compared to embedding vectors in the vector database, according to a similarity metric. The similarity metric may be based on a distance (e.g., Euclidean distance, Manhattan distance, Cosine distance, Hamming distance, Minkowski distance, Chebyshev distance, Jaccard distance, Haversine distance, Sorensen-Dice distance, etc.) between embedding vectors, with smaller distances representing more similarity and larger distances representing less similarity. The search of the vector database may be performed using any suitable technique, such as brute force, k-dimensional trees, ball trees, locality-sensitive hashing (LSH), k-nearest neighbor (kNN), approximate nearest neighbor (e.g., Facebook™ AI Similarity Search, Approximate Nearest Neighbors Oh Yeah (ANNOY), scalable nearest neighbors (ScaNN), etc.), Hierarchical Navigable Small World (HNSW) graphs, Voronoi diagrams, vector quantization, product quantization (PQ), random projection trees, lattice-based methods (e.g., cover tree, vantage point tree, etc.), and/or the like. It should be understood that the search will return representations of historical inputs that are semantically similar to the current input (e.g., for which the similarity metric satisfies a threshold representing sufficient similarity). The representation of a historical input may comprise or consist of a unique input identifier for that historical input.

At a high level, estimator AI agent 160E predicts the cost of an inference based on the historical costs for similar inferences. The predicted cost may be for the entire inference from input to response, or alternatively, for only a portion of the inference. Estimator AI agent 160E may utilize AI model(s) 162E and/or tool(s) 164E to predict the cost of applying AI model 162P to the current input, based on relevant data associated, within historical data 172, with the input identifier(s), which were identified by discriminator AI agent 160D. Essentially, the input identifier(s) represent a filtered list of historical inputs that are similar to the current input.

Estimator AI agent 160E may utilize any suitable technique for predicting the cost of an inference. In an embodiment, estimator AI agent 160E may utilize a RAG architecture. In this case, the retrieval component may comprise retrieving relevant data for each of the historical inputs identified by the input identifier(s) found by discriminator AI agent 160D, and/or retrieving a cost model for performing AI agent 160P. This retrieval may be performed by a tool 164E. The generation component may comprise generating the predicted cost based on the relevant data that were retrieved for the historical inputs and/or the cost model that was retrieved for performing AI agent 160P. This generation may be performed by an AI model 162E.

The retrieval component may retrieve data and/or metadata, as the relevant data, from historical data 172, for each similar input identified by one of the input identifier(s). In particular, estimator AI agent 160E may query historical data 172 (e.g., using a tool 164E) using each input identifier as an index, to retrieve relevant data associated with that input identifier. The relevant data, retrieved by estimator AI agent 160E for a particular similar input, may comprise data and/or metadata collected over the entire lifecycle or a portion of the lifecycle of at least one inference that was performed in the past, by an AI agent 160, to produce a response for the similar input, and preferably over a plurality of inferences. The lifecycle of an inference may comprise numerous stages, including, for example, a call to a tool 164 (e.g., to perform a search), a call to an AI model 162 (e.g., to generate a response), model routing, inter-agent communications with another AI agent 160, infrastructural processing time, and/or the like. The data may comprise the historical input associated with the input identifier, an identifier and/or other data about the AI agent 160 which performed the historical inference for the historical input, one or more logs for the historical inference (e.g., for each component in the stack of the AI agent 160 that performed the historical inference), and/or the like. The metadata may comprise one or more utilization metrics for each of one or more stages, a subset of stages, and/or all of the stages in the lifecycle of the historical inference performed for the historical input associated with the input identifier, over one or a plurality of inferences (e.g., averaged or otherwise aggregated over the plurality of inferences). Concrete examples of a utilization metric include, without limitation, the number of tokens utilized, computational time, resource utilization for a computational resource or other resource, size of a data payload, number of model calls, number of tool calls, number of calls to other AI agents 160, and the like.

The retrieval component may also retrieve a cost model. If the AI model(s) 162P or performing AI agent 160P (e.g., which utilizes AI model(s) 162P), to which the current input is intended to be submitted, is known, the specific cost model for the respective AI model(s) 162P or performing AI agent 160P may be retrieved. For example, as discussed elsewhere herein, each performing AI agent 160P may publish respective provider information, including a respective cost model, to distributed ledger 180. In this case, estimator AI agent 160E may query distributed ledger 180 (e.g., using an identifier of performing AI agent 160P) to retrieve the provider information, including the cost model for performing AI agent 160P, from distributed ledger 180.

The cost model for an AI model 162P or performing AI agent 160P may comprise an economic or pricing model, resource-utilization model, energy-consumption model, ecological model, and/or the like. A pricing model may comprise or algorithmically determine a single price, a tiered pricing structure, a price per model call, a price per tool call, a price per token, a price per computation, a price per successful outcome, a price per other unit, and/or the like. A resource-utilization model may comprise or algorithmically determine a measure of utilization for one or more computational resources or other resources, per unit, such as per model call, per tool call, per token, per computation, per successful outcome, and/or the like. An energy-consumption model may comprise or algorithmically determine a measure of energy consumption per unit, such as per model call, per tool call, per token, per computation, per successful outcome, and/or the like. An ecological model may comprise or algorithmically determine a measure of ecological impact, such as greenhouse gas emissions (e.g., carbon dioxide emissions), per unit, such as per model call, per tool call, per token, per computation, per successful outcome, and/or the like. It should be understood that a measure of ecological impact may represent an amount of damage to the environment that is caused by an inference performed by the respective AI model 162P or performing AI agent 160P.

In the generation component, estimator AI agent 160E may apply an AI model 162E to the relevant data (e.g., utilization metric(s)) and/or cost model, retrieved in the retrieval component. AI model 162E may comprise a discriminative machine-learning model and/or one or more statistical models. Examples of suitable discriminative machine-learning models include, without limitation, a support vector machine (SVM), a regression model, an automated machine learning (AutoML) model, and the like. In an embodiment, AI model 162E may be a simulation model, informed by the relevant data, that simulates application of AI model 162P to the received input, and outputs one or more utilization metrics, representing a predicted resource utilization by AI model 162P, given the received input.

The output of AI model 162E may comprise a prediction of one or more utilization metrics. It should be understood that AI model 162E may predict the utilization metric(s) for an inference performed on the current input, based on the utilization metric(s) in the relevant data for the historical inference(s) performed on the similar historical input(s). For instance, for a token-based AI model 162P, AI model 162E may predict the number of tokens required to generate a response to the current input, based on the number of tokens required to generate responses for the historical input(s). Estimator AI agent 160E may apply the cost model to the predicted utilization metric(s), output by AI model 162E, to determine the predicted cost.

Alternatively or additionally, the output of AI model 162E may comprise a prediction of the cost. In particular, AI model 162E may directly generate the predicted cost by internally generating the utilization metric(s), and then applying the cost model to those utilization metric(s) to compute the predicted cost. In this case, estimator AI agent 160E does not need to subsequently apply the cost model to the utilization metric(s). Alternatively, AI model 162E may predict the cost in any other suitable manner. The output of AI model 162E may comprise the predicted cost, and optionally one or more utilization metrics and/or other information.

In an alternative embodiment, estimator AI agent 160E may, instead of predicting the cost, predict one or more utilization metrics. In this case, another entity could retrieve (e.g., from distributed ledger 180) and apply the cost model to the utilization metric(s), to calculate the predicted cost based on the utilization metric(s). For instance, this other entity could be end client 310, performing AI agent 160P (e.g., in the second and third arrangements), intermediary 520 (e.g., in the fourth and fifth arrangements), or discriminator AI agent 160D.

It should be understood that the predicted cost will depend on which cost model(s) are used. For instance, if a pricing model is used, the predicted cost will comprise an economic cost. If a resource-utilization model is used, the predicted cost will comprise a computational cost. If an energy-consumption model is used, the predicted cost will comprise an energy consumption. If an ecological model is used, the predicted cost will comprise an ecological cost. The predicted cost may comprise only one or any combination of these types of costs and/or other types of costs.

In the first arrangement, end client 310 may submit a prospective input to discriminator AI agent 160D. Discriminator AI agent 160D may receive the input, and search historical data 172, as discussed elsewhere herein, to identify one or more input identifiers that each identifies a historical input that is similar to the received input. Discriminator AI agent 160D may send the input identifier(s) to estimator AI agent 160E. Estimator AI agent 160E may receive the input identifier(s), and predict a cost of performing an inference, using at least one AI model 162P (e.g., via performing AI agent 160P), on the received input, based on relevant data associated with each of the input identifier(s), as discussed elsewhere herein. Estimator AI agent 160E may return the predicted cost to discriminator AI agent 160D. Discriminator AI agent 160D may, in response to sending the input identifier(s), receive the predicted cost from estimator AI agent 160E, and return this predicted cost to end client 310. End client 320 may utilize the predicted cost to determine whether or not to actually perform the inference on the prospective input. When determining to perform the inference, end client 320 may submit the input to performing AI agent 160P.

In the second arrangement, end client 310 may submit an input to performing AI agent 160P. Performing AI agent 160P may receive the input from end client 310, and, before performing an inference on the received input (e.g., using AI model 162P), call discriminator AI agent 160D using the received input. Discriminator AI agent 160D may be a tool 164P of performing AI agent 160P. Discriminator AI agent 160D may receive the input, and search historical data 172, as discussed elsewhere herein, to identify one or more input identifiers that each identifies a historical input that is similar to the received input. Discriminator AI agent 160D may send the input identifier(s) to estimator AI agent 160E. Estimator AI agent 160E may receive the input identifier(s), and predict a cost of using performing AI agent 160P to perform an inference on the received input, based on relevant data associated with each of the input identifier(s), as discussed elsewhere herein. Estimator AI agent 160E may return the predicted cost to discriminator AI agent 160D. Discriminator AI agent 160D may, in response to sending the input identifier(s), receive the predicted cost from estimator AI agent 160E, and return this predicted cost to performing AI agent 160P. Performing AI agent 160P may, in response to the call to discriminator AI agent 160D, receive the predicted cost from discriminator AI agent 160D. Performing AI agent 160P may then determine whether or not to perform the inference based on the predicted cost.

In the third arrangement, end client 310 may submit an input to performing AI agent 160P. Performing AI agent 160P may receive the input from end client 310, and, before performing an inference on the received input (e.g., using AI model 162P), call discriminator AI agent 160D using the received input. Discriminator AI agent 160D may receive the input, and search historical data 172, as discussed elsewhere herein, to identify one or more input identifiers that each identifies a historical input that is similar to the received input. Discriminator AI agent 160D may return the input identifier(s) to performing AI agent 160P. Performing AI agent 160P may, in response to the call to discriminator AI agent 160D, receive the input identifier(s) from discriminator AI agent 160D. Performing AI agent 160P may then call estimator AI agent 160E using the input identifier(s) received from discriminator AI agent 160D. Estimator AI agent 160E may receive the input identifier(s), and predict a cost of using performing AI agent 160P to perform an inference on the received input, based on relevant data associated with each of the input identifier(s), as discussed elsewhere herein. Estimator AI agent 160E may return the predicted cost to performing AI agent 160P. Discriminator AI agent 160D and/or estimator AI agent 160E may be tool(s) 164P of performing AI agent 160P. Performing AI agent 160P may, in response to the call to estimator AI agent 160E, receive the predicted cost from estimator AI agent 160D. Performing AI agent 160P may then determine whether or not to perform the inference based on the predicted cost.

In each of the second and third arrangements, when performing AI agent 160P determines to perform the inference, performing AI agent 160P may initiate performance of the inference by utilizing AI model(s) 162P and/or tool(s) 164P to produce a response to the input received from end client 310. It is contemplated that the inference will comprise applying at least one AI model 162P to the received input. However, the inference could alternatively or additionally comprise calling a tool 164P or another AI agent 160 that applies an AI model 162 to the received input, or to an input that is derived from, or that otherwise pertains to, the received input. Performing AI agent 160P may then return the response to end client 310.

Conversely, in each of the second and third arrangements, when performing AI agent 160P determines not to perform the inference, performing AI agent 160P may automatically block the performance of the inference, at least temporarily. It is contemplated that this blocking will prevent any AI model 162, including AI model 162P, from being applied to the input received from end client 310. In this case, performing AI agent 160P may notify end client 310 that performance of the inference was blocked. For example, if end client 310 is a user, performing AI agent 160P may respond to the received input by outputting a notification to the graphical user interface of agentic interface 165 of performing AI agent 160P, and potentially one or more inputs for overriding the blockade and performing the inference despite the predicted cost (e.g., if the user has appropriate permissions), confirming the blockade, editing the input, submitting a new input, and/or the like. If end client 310 is a software entity, performing AI agent 160P may respond to the received input by returning a notification via the application programming interface of agentic interface 165 of performing AI agent 160P. In each case, the notification may indicate that the inference was not performed, a reason why the inference was not performed (e.g., because it would exceed a predefined cost budget), and/or the like.

In the fourth arrangement, end client 310 may submit an input to intermediary 520. Intermediary 520 may receive the input from end client 310, and, before performing an inference on the received input (e.g., using performing AI agent 160P, which may call AI model 162P), call discriminator AI agent 160D using the received input. Discriminator AI agent 160D may receive the input, and search historical data 172, as discussed elsewhere herein, to identify one or more input identifiers that each identifies a historical input that is similar to the received input. Discriminator AI agent 160D may send the input identifier(s) to estimator AI agent 160E. Estimator AI agent 160E may receive the input identifier(s), and predict a cost of using performing AI agent 160P to perform an inference on the received input, based on relevant data associated with each of the input identifier(s), as discussed elsewhere herein. Estimator AI agent 160E may return the predicted cost to discriminator AI agent 160D. Discriminator AI agent 160D may, in response to sending the input identifier(s), receive the predicted cost from estimator AI agent 160E, and return this predicted cost to intermediary 520. Intermediary 520 may, in response to the call to discriminator AI agent 160D, receive the predicted cost from discriminator AI agent 160D. Intermediary 520 may then determine whether or not to perform the inference based on the predicted cost.

In the fifth arrangement, end client 310 may submit an input to intermediary 520. Intermediary 520 may receive the input from end client 310, and, before performing an inference on the received input (e.g., using performing AI agent 160P, which may call AI model 162P), call discriminator AI agent 160D using the received input. Discriminator AI agent 160D may receive the input, and search historical data 172, as discussed elsewhere herein, to identify one or more input identifiers that each identifies a historical input that is similar to the received input. Discriminator AI agent 160D may return the input identifier(s) to intermediary 520. Intermediary 520 may, in response to the call to discriminator AI agent 160D, receive the input identifier(s) from discriminator AI agent 160D. Intermediary 520 may then call estimator AI agent 160E using the input identifier(s) received from discriminator AI agent 160D. Estimator AI agent 160E may receive the input identifier(s), and predict a cost of using performing AI agent 160P to perform an inference on the received input, based on relevant data associated with each of the input identifier(s), as discussed elsewhere herein. Estimator AI agent 160E may return the predicted cost to intermediary 520. Intermediary 520 may, in response to the call to estimator AI agent 160E, receive the predicted cost from estimator AI agent 160D. Intermediary 520 may then determine whether or not to perform the inference based on the predicted cost.

In each of the fourth and fifth arrangements, when intermediary 520 determines to perform the inference, intermediary 520 may initiate performance of the inference by calling performing AI agent 160P, via an application programming interface of agentic interface 165 of performing AI agent 160P, using the input received from end client 310, to thereby submit the received input to performing AI agent 160P. Again, while it is contemplated that the inference will comprise performing AI agent 160P applying at least one AI model 162P to the received input, the inference could alternatively or additionally comprise performing AI agent 160P calling a tool 164P or another AI agent 160 that applies an AI model 162 to the received input, or to an input that is derived from, or that otherwise pertains to, the received input. Performing AI agent 160P may return the response to intermediary 520, and intermediary 520 may, as a response to calling performing AI agent 160P, receive the response. Intermediary 520 may then return the response, received from performing AI agent 160P, to end client 310.

Conversely, in each of the fourth and fifth arrangements, when intermediary 520 determines not to perform the inference, intermediary 520 may automatically block the performance of the inference, at least temporarily. This blocking may consist of not making any call to performing AI agent 160P using the input, received from end client 310. In this case, intermediary 520 may notify end client 310 that performance of the inference was blocked. For example, if end client 310 is a user, intermediary 520 may respond to the received input by outputting a notification to a graphical user interface of intermediary 520, and potentially one or more inputs for overriding the blockade and performing the inference despite the predicted cost (e.g., if the user has appropriate permissions), confirming the blockade, editing the input, submitting a new input, and/or the like. If end client 310 is a software entity, intermediary 520 may respond to the received input by returning a notification via an application programming interface of intermediary 520. In each case, the notification may indicate that the inference was not performed, a reason why the inference was not performed (e.g., because it would exceed a predefined cost budget), and/or the like.

In each of the second, third, fourth, and fifth arrangements, the determining software entity (i.e., performing AI agent 160P in the second and third arrangements, and intermediary 520 in fourth and fifth arrangements) may determine whether or not to perform the inference based on whether or not the predicted cost satisfies one or more criteria. In an embodiment, the criteria comprises or consists of the predicted cost satisfying a threshold, which may represent a specific budget. For example, if the predicted cost is greater than or equal to the threshold, the software entity may determine not to perform the inference. Conversely, if the predicted cost is less than the threshold, the software entity may determine to perform the inference. The threshold may be a user setting, organizational setting, system setting, or the like, that is potentially configurable with appropriate permissions. In an embodiment in which the predict cost comprises a plurality of different predicted costs (e.g., economic cost, computational cost, energy cost, ecological cost, etc.), each of the plurality of predicted costs may be compared to a respective threshold, representing a budget for that particular type of cost. The software entity may determine not to perform the inference if at least one of the plurality of predicted costs satisfies its respective threshold (or alternatively, only if all of the plurality of predicted costs satisfy their respective thresholds). Alternatively, the software entity may aggregate the plurality of predicted costs into a single predicted cost that is compared to a threshold, representing an overall budget.

In general, in the second, third, fourth, and fifth arrangements, a session may comprise end client 310 submitting a first input, performing AI agent 160P receiving the first input either directly or via intermediary 520, performing AI agent 160P inferring a first response to the first input using at least one AI model 162P, performing AI agent 160P returning the first response to end client 310 either directly or via intermediary 520, end client 310 submitting a second input, performing AI agent 160P receiving the second input either directly or via intermediary 520, performing AI agent 160P inferring a second response to the second input using at least one AI model 162P, performing AI agent 160P returning the second response to end client 310 either directly or via intermediary 520, and so on and so forth until the session ends by an operation by end client 310, an operation by AI agent 160P, intermediary 520, or other software entity, a timeout since the last input from end client 310, and/or the like. However, according to disclosed embodiments, performing AI agent 160P or intermediary 520 may automatically block one or more inferences, within the session, based on the predicted cost, and instead of returning a response to the respective input, return a notification that the inference was blocked. In an embodiment, a blockade may be overridden by end client 310 (e.g., assuming appropriate permissions), such that the inference is performed despite the predicted cost.

As potential alternatives to the first, second, and fourth arrangements, instead of end client 310, performing AI agent 160P, or intermediary 520, respectively, interacting with discriminator AI agent 160D, the respective entity could interact with estimator AI agent 160E. In this case, estimator AI agent 160E may receive the input from the respective entity, and, before generating the predicted cost, call discriminator AI agent 160D (e.g., as a tool 164E) using the received input. Discriminator AI agent 160D may identify one or more input identifiers, as discussed elsewhere herein, and return the input identifier(s) to estimator AI agent 160E. Estimator AI agent 160 may, in response to the call of discriminator AI agent 160D, receive the input identifier(s), and generate the predicted cost using the input identifier(s), as discussed elsewhere herein. Estimator AI agent 160 may return the predicted cost to the respective entity, which may utilize the predicted cost in the same manner as in the respective arrangement. For the sake of simplicity, these alternative arrangements will not be repetitively described herein. However, it should be understood that any description of the first, second, and fourth arrangements may apply equally to these alternative first, second, and fourth arrangements.

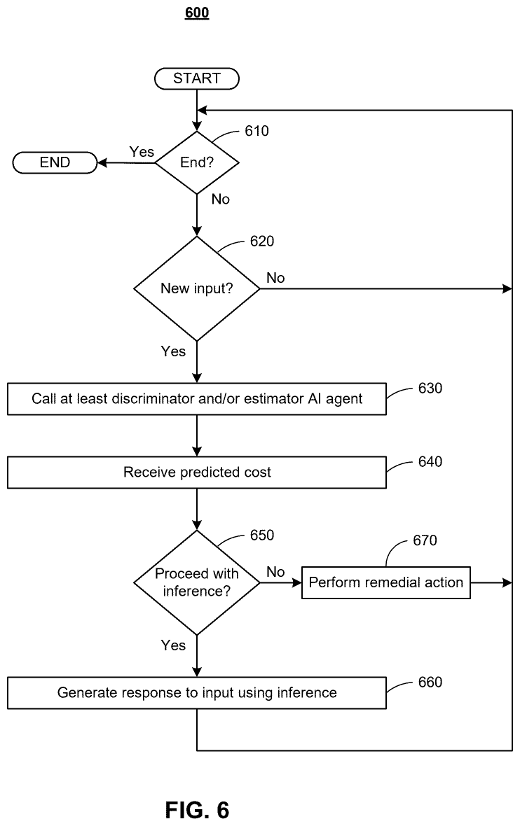

FIG. 6 illustrates an example process 600 for dynamic and adaptive dynamic and adaptive prediction of inference costs prior to the utilization of AI models 162, according to an embodiment. Process 600 may be implemented by an implementing entity, which may be end client 310 (e.g., in the first and sixth arrangements), performing AI agent 160P (e.g., in the second and third arrangements), or intermediary 520 (e.g., in the fourth and fifth arrangements).

While process 600 is illustrated with a certain arrangement and ordering of subprocesses, process 600 may be implemented with fewer, more, or different subprocesses and a different arrangement and/or ordering of subprocesses. Furthermore, any subprocess, which does not depend on the completion of another subprocess, may be executed before, after, or in parallel with that other independent subprocess, even if the subprocesses are described or illustrated in a particular order.

Subprocess 610 may determine whether or not to end process 600. Process 600 may continue for as long as a session is active between end client 310 and either discriminator AI agent 160D (e.g., in the first arrangement), performing AI agent 160P (e.g., in the second or third arrangement), or intermediary 520 (e.g., in the fourth or fifth arrangement). Process 600 may end when the session ends. However, it should be understood that there may be a plurality of independent sessions that are active at any given time. When determining to end (i.e., “Yes” in subprocess 610), process 600 may end. Otherwise, when not determining to end (i.e., “No” in subprocess 610), process 600 may proceed to subprocess 620.

Subprocess 620 may determine whether or not a new input has been received from end client 310. If end client 310 is a user, the received input may comprise or consist of a natural-language expression, representing a prompt, query, question, request, instruction, and/or the like. Alternatively, if end client 310 is a software entity, the received input may comprise a prompt, query, question, request, instruction, and/or the like, encoded in the particular language used by the software entity (e.g., JSON, XML, etc.). However, it should be understood that there is no reason that a software entity could not also submit an input comprising or consisting of a natural-language expression. In any case, the implementing entity receives the input, which indicates a task to be performed by performing AI agent 160P. This task will generally require an inference using AI model 162P. When a new input is received (i.e., “Yes” in subprocess 620), process 600 may proceed to subprocess 630. Otherwise, while no new input is received (i.e., “No” in subprocess 620), process 600 may return to subprocess 610.

Subprocess 630 may comprise calling at least one of discriminator AI agent 160D and/or estimator AI agent 160E using the input, received in subprocess 620. The received input may be pre-processed before being sent. Alternatively, the raw unprocessed input, as received from end client 310, may be sent. In an embodiment in which implementing entity is an AI agent 160, the AI agent 160 may send the input to discriminator AI agent 160D and/or estimator AI agent 160E using an inter-agent communication protocol (e.g., MCP, ACP, A2A, ANP, etc.).

In the first, second, and fourth arrangements, the implementing entity does not communicate directly with estimator AI agent 160E. Rather, the implementing entity sends the received input to discriminator AI agent 160D, which identifies one or more input identifiers, and calls estimator AI agent 160E using the input identifier(s). Estimator AI agent 160E predicts the cost of performing an inference on the received input, based on the input identifier(s). This predicted cost is relayed back through discriminator AI agent 160D to the implementing entity.

Similarly, in the alternative first, second, and fourth arrangements, the implementing entity does not communicate with discriminator AI agent 160D. Rather, the implementing entity sends the received input to estimator AI agent 160E, which calls discriminator AI agent 160D to identify one or more input identifiers. Then, estimator AI agent 160E predicts the cost of performing an inference on the received input, based on the input identifier(s). This predicted cost is returned to the implementing entity.

In the third and fifth arrangements, the implementing entity communicates directly with both discriminator AI agent 160D and estimator AI agent 160E. In particular, the implementing entity calls discriminator AI agent 160D using the received input. Discriminator AI agent 160D identifies and returns one or more input identifiers. Then, the implementing entity calls estimator AI agent 160E using the input identifier(s). Estimator AI agent 160E predicts the cost of performing an inference on the received input, based on the input identifier(s), and returns the predicted cost to the implementing entity.

As discussed elsewhere herein, discriminator AI agent 160D may search historical data 172 (e.g., via a tool 164D) to identify one or more historical inputs that are most similar to the received input. For example, historical data 172 may comprise a vector database. In this case, discriminator AI agent 160D may convert the received input into an input embedding vector, and identify one or more reference embedding vectors in the vector database that are most similar to the input embedding vector, based on a similarity metric, and/or that are sufficiently similar (e.g., for which the similarity metric satisfies a threshold). Each of these reference embedding vectors may be associated with an input identifier, representing the historical input from which the reference embedding vector was created. The input identifier for each historical input, for which the corresponding reference embedding vector is sufficiently similar to the input embedding vector (e.g., for which the similarity metric between the input embedding vector and reference embedding vector satisfies a threshold), may be utilized by estimator AI agent 160E. It should be understood that this is one non-limiting example of a search technique that may be employed by discriminator AI agent 160D, and that numerous other search techniques may be employed by discriminator AI agent 160D to identify historical inputs that are similar to the received input.

As discussed elsewhere herein estimator AI agent 160E may predict the cost of performing an inference on the received input. It is contemplated that the inference would use at least one AI model 162, such as AI model 162P, on the received input. In particular, estimator AI agent 160E may retrieve relevant data associated with the input identifier(s) output by discriminator AI agent 160D. The relevant data may comprise historical utilization metric(s) for the historical input identified by each of the input identifier(s). Estimator AI agent 160E may also retrieve a cost model for the AI model(s) 162 or the overarching performing AI agent 160P that will be used to perform the inference. The cost model may be retrieved from provider information, stored on distributed ledger 180, for performing AI agent 160P, as discussed elsewhere herein. The cost model may comprise an economic or pricing model, a computational model, a resource-utilization model, an energy-consumption model, an ecological model, and/or the like. Estimator AI agent 160E may utilize one or more AI models 162E and/or one or more tools 164E to predict the cost, based on the relevant data, including the utilization metrics, and/or the cost model.

Subprocess 640 may receive the predicted cost that was determined by estimator AI agent 160E. As discussed elsewhere herein, the implementing entity may receive the predicted cost either directly from estimator AI agent 160E, or indirectly from estimator AI agent 160E via discriminator AI agent 160D. The predicted cost may represent any type of cost or combination of costs. For example, the cost could represent an economic cost (e.g., amount of money), a computational cost (e.g., number of tokens, resource utilization, computational time, etc.), an energy cost (e.g., an amount of energy consumed), an ecological cost (e.g., an amount of greenhouse gas emissions), and/or the like. An economic cost, which may be a monetary cost, may include model cost, tool cost, energy cost, and/or the like, and preferably represents the overall cost for performing AI agent 160P to complete the task represented by the input received from end client 310.

Subprocess 650 may determine whether or not to perform the inference based on the predicted cost. For instance, subprocess 650 may determine whether or not to perform the inference based on whether or not the predicted cost satisfied one or more criteria. As one example, subprocess 650 may determine to perform the inference when the predicted cost is less than a threshold, and determine to not perform the inference when the predicted cost is equal to or greater than the threshold. The threshold may represent a budget that is set, for example, by a user, organization, platform 110, or the like. When determining to perform the inference (i.e., “Yes” in subprocess 650), process 600 may proceed to subprocess 660. Otherwise, when determining not to perform the inference (i.e., “No” in subprocess 650), process 600 may proceed to subprocess 670.

Subprocess 660 may perform the inference to generate a response to the received input. In the first arrangement, in which the implementing entity is end client 310, subprocess 660 may comprise end client 310 submitting the input to performing AI agent 160P, which performs the inference on the input using one or more AI models 162P and/or tools 164P. In the second and third arrangements, subprocess 660 may comprise performing AI agent 160P performing the inference on the input using one or more AI models 162P and/or tools 164P. In the fourth and fifth arrangements, subprocess 660 may comprise intermediary 520 submitting the input to performing AI agent 160P, which performs the inference on the input using one or more AI models 162P and/or tools 164P. In each case, the response, generated by performing AI agent 160P, may be returned to end client 310.

Subprocess 670 may execute one or more remedial actions. It is generally contemplated that the remedial action(s) would comprise or consist of blocking the performance of the inference, and particularly blocking application of AI model(s) 162P and/or other AI model(s) 162 to the received input. However, the remedial action(s) may comprise other remedial actions, such as modifying or initiating modification of the received input, modifying adaptive governance policy 174, and/or the like. In these cases, instead of blocking the performance of the inference, the inference may be automatically performed after modification of the received input and/or after modification of adaptive governance policy 174.

When blocking performance of the inference, which includes blocking of the application of an AI model 162 (e.g., AI model 162P) to the received input, the implementing entity may notify end client 310. For example, if end client 310 is a user, the implementing entity may generate and output a notification that informs the user that a response was not generated. In this case, the notification may include the predicted cost, and potentially the one or more criteria which resulted in the determination in subprocess 650. In addition, if the user has sufficient privileges, the implementing entity may output an input that, when selected, overrides the blockade and proceeds with the inference despite the predicted cost. If end client 310 is a software entity, the notification may be returned to the software entity, which may similarly have the ability to override the blockade, assuming the software entity possesses sufficient privileges. Alternatively, end client 310 could revise the input and try again.

When modifying the input, the implementing entity may generate and output a proposed modification to the input. For example, the implementing entity could utilize internal logic, an AI model 162, a tool 164, another AI agent 160, and/or the like, to generate a modified input (e.g., by reducing the number of tokens, shortening the context window, etc.) that would reduce the predicted cost of performing the inference (e.g., to less than the threshold, representing the budget, for determining whether or not to block the inference). The implementing entity could output this proposed modified input to end client 310. In addition, if end client 310 is a user, the implementing entity may output an input that, when selected, proceeds with the inference using the modified input, potentially along with an input that, when selected, proceeds with the inference using the original input. Alternatively, the implementing entity may automatically proceed with the inference using the modified input, without requiring approval from end client 310. As another alternative, instead of automatically modifying the input, the implementing entity may prompt end client 310 to modify the input. It should be understood that, in this case, a subsequent submission of a modified or entirely new input, by end client 310, may trigger a new iteration of the “Yes” branch in subprocess 620.

When modifying adaptive governance policy 174, the implementing entity may adjust the value of each of one or more parameters in adaptive governance policy 174 that pertain to the inference to be performed by performing AI agent 160P. For instance, performing AI agent 160P could be throttled down, for example, by adding or decreasing a limit on the utilization of one or more computational resources, blocking the utilization of one or more particular AI models 162P, blocking the utilization of one or more particular tools 164, blocking the utilization of one or more other AI agents 160, adding or decreasing a limit on the number of tokens, and/or the like. This throttling down of performing AI agent 160P, potentially including the throttling down of individual components in the stack of performing AI agent 160P, may be designed to prevent the costs of inference from exceeding a threshold (e.g., the same threshold used to determine whether or not to perform inference in subprocess 650). In this case, the inference on the received input may be allowed to proceed under the modified adaptive governance policy 174. In other words, adaptive governance policy 174 is relied upon to prevent cost overruns.

The disclosed cost prediction has numerous use cases. For instance, disclosed embodiments may be used to design cost-efficient prompts for AI model 162P by reviewing the predicted costs for various prompts representing the same task, prior to actually utilizing any of the prompts. In addition, disclosed embodiments may prevent or reduce the risk of endless-loop AI agents 160. An endless-loop AI agent 160 is one that gets stuck in an endless loop of actions, because it never reaches a satisfactory outcome. In this case, an inference will eventually be blocked in subprocess 670, since, at some point, the predicted cost will hit the threshold representing the budget, thereby breaking the endless loop. As another example, embodiments may be used, not only to predict the monetary cost of executing performing AI agent 160P, but to predict the computational time for an execution of performing AI agent 160P, the energy consumption for the execution of performing AI agent 160P, and/or the greenhouse gas emissions attributable to the execution of performing AI agent 160P.

In an embodiment, the disclosed cost prediction may be used in combination with the performance optimization discussed elsewhere herein. In particular, the cost predictions for each performing AI agent 160P may be used to derive a model of expected costs for that performing AI agent 160P. The cost predictions may be collected by an observability tool, and the model of expected costs may be generated (e.g., by scoring AI agent 160S, other AI agent 160, or other software entity) from the collected cost predictions. In addition, performance telemetry 320 may comprise actual costs incurred by performing AI agent 160P. In this case, scoring AI agent 160S may, in subprocess 430, compare the actual costs to the expected costs, determined from the model of expected costs, to determined a deviation between actual costs and expected costs. This deviation between actual and expected costs may be used as a factor when determining whether the deviation in the performance of AI agent 160P is significant in subprocess 440. For instance, if this deviation indicates that the actual costs exceed the expected costs by a significant amount (e.g., threshold amount), one or more parameters in adaptive governance policy 174 may be responsively modified, for example, to throttle down performing AI agent 160P.

### 5. Decentralized Agentic Provider Selection

In an embodiment, a distributed ledger 180 is provided for efficient, market-driven, verifiable, and autonomous interactions between consumer AI agents 160 and provider entities, such as other AI agents 160 or tools 164 (e.g., an AI-based tool 164). In particular, distributed ledger 180 may be leveraged and enhanced to provide a negotiation and transaction layer between a consumer AI agent 160 and provider entities. It should be understood that an AI agent 160 may be a consumer AI agent 160C in one instance and a provider entity in another instance.

This negotiation and transaction layer ensures optimal resource allocation and prevents inefficient and costly selections in a dynamic, multi-agent, multi-tool environment. In particular, AI agents 160 and provider entities may utilize distributed ledger 180 to dynamically negotiate and agree upon one or more cost and/or performance parameters for utilization of the provider entities to perform a task. It is generally contemplated that the cost parameter(s) represent an economic cost (e.g., monetary cost) for completing the task, but the cost parameter(s) could represent other types of costs, such as computational costs, energy costs, ecological costs, and/or the like, for completing the task. Examples of performance parameters include, without limitation, a maximum or average computational time for completing the task (e.g., total generation time), a maximum or average number of tokens, a maximum or average time to first token, a maximum or average time per output token, and/or the like.

In an embodiment, distributed ledger 180 is a blockchain. A blockchain provides a transparent, auditable, and immutable record of service costs, performance parameters, and/or capabilities of the provider entities. This enables consumer AI agents 160 to efficiently and reliably discover and select optimal provider entities based on real-time market rates and estimated resource consumption, and provides a framework for human oversight or arbitration of autonomous transactions.

The negotiation and transaction layer, utilizing distributed ledger 180 (e.g., a blockchain), may be combined with the performance optimization and/or cost prediction disclosed elsewhere herein. For example, the expected performance telemetry for a performing AI agent 160P may be determined, at least in part, on the performance parameters, recorded for that performing AI agent 160P, on distributed ledger 180. As another, the cost prediction may be calculated, at least in part, based on the recorded cost model for the corresponding provider entity in distributed ledger 180. This enables a consumer AI agent 160 to implement real-time market-driven routing of tasks.

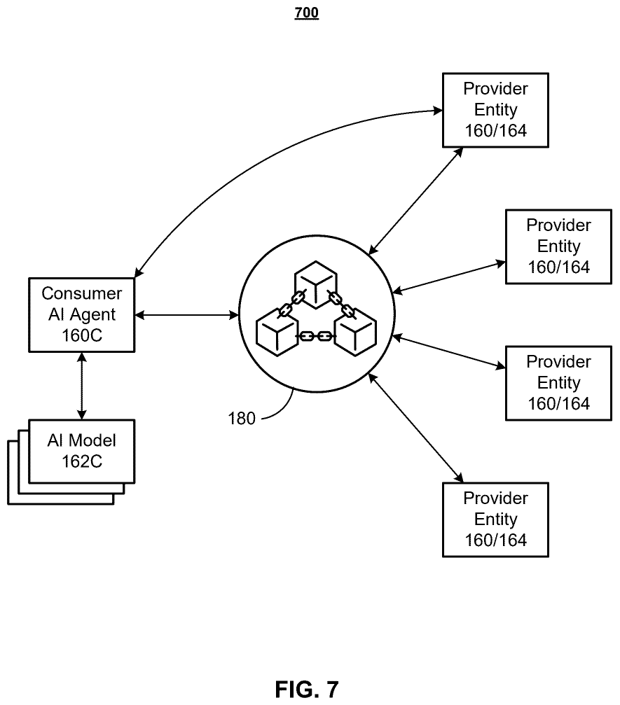

FIG. 7 illustrates an example data flow 700 for decentralized autonomous agentic provider selection, according to an embodiment. It should be understood that data flow 700 is shown by way of example, rather than limitation, and that a myriad other arrangements of the data flow are possible. In addition, while only a single consumer AI agent 160C and several provider entities, which may be AI agents 160 and/or tools 164, are illustrated, data flow 700 may comprise any number of consumer AI agents 160C and provider entities.

Consumer AI agent 160C may be any AI agent 160, including any of the other AI agents 160 discussed herein, such as performing AI agent 160P, scoring AI agent 160S, discriminator AI agent 160D, and estimator AI agent 160E. In addition, a provider entity that is an AI agent 160 may also be any AI agent 160, including any of the other AI agents 160 discussed herein, such as performing AI agent 160P, scoring AI agent 160S, discriminator AI agent 160D, and estimator AI agent 160E. Furthermore, consumer AI agent 160C may itself be a provider entity, relative to another consumer AI agent 160C.

Provider entities (e.g., AI agents 160 and/or tools 164) may publish respective provider information to distributed ledger 180, thereby ensuring that the provider information is transparently available to all consumer AI agents 160C. The provider information for each provider entity may comprise a cost model for each one or more services (e.g., operations or endpoints, within an application programming interface of the provider entity) offered by the provider entity. The cost model may comprise an economic or pricing model (e.g., single flat price, tiered pricing structure, algorithm for determining price, price per model call, price per tool call, price per token, computation, successful outcome, or other unit, etc.), a resource-utilization model (e.g., utilization of each of one or more computational resources per token or other unit, etc.), an energy-consumption model (e.g., energy usage per token or other unit, etc.), an ecological model (e.g., greenhouse gas emissions per token or other unit), and/or the like. The provider information may also include one or more performance parameters for each service offered by the respective provider entity. These performance parameter(s) may include, without limitation, an estimated cost (e.g., predicted using estimator AI agent 160E), computational requirements, predicted latency, data usage, and/or other governing metrics that are specific to each service. The provider information may also include one or more capabilities of the respective provider entity, indicating the service(s) or tasks(s) that the respective provider entity is capable of providing. Each provider entity may dynamically update the provider information in distributed ledger 180, whenever the cost model, performance parameter(s), and/or capability(ies) change, so that the most current provider information is always available in distributed ledger 180. It should be understood that all of the past provider information may also remain available within distributed ledger 180, establishing a historical record of all updates to the provider information for each provider entity.

Before or at the time of selecting a provider entity for a service (e.g., sub-task), consumer AI agent 160C may query distributed ledger 180 for the service, to discover provider entities that are candidates for providing that service (e.g., based on the capabilities specified in their respective provider information). The query may return the provider information, including pricing information and/or performance parameters, for each candidate from distributed ledger 180. Consumer AI agent 160C may select one or more of the returned candidates. This selection may be performed using AI model 162C. For instance, consumer AI agent 160C may generate a prompt that comprises the provider information for each candidate and an instruction to select one of the candidates based on one or more factors. These factor(s) may comprise minimizing cost (e.g., economic, computational, energy, and/or ecological cost), maximizing performance, minimizing computational time, maximizing security, and/or the like. Consumer AI agent 160C may apply AI model 162C to the prompt to generate the selection of one or more candidates. It should be understood that, in this case, consumer AI agent 160C may utilize a RAG architecture to select the candidate(s), with the query of distributed ledger 180 acting as the retrieval component and the application of AI model 162C acting as the generation component. In an alternative embodiment, the candidate(s) may be selected, from among those returned by the query, in some other manner, such as using a rule-based algorithm (e.g., selecting the returned candidate(s) having the lowest cost, maximum performance, lowest computational time, etc.) or mathematical algorithm (e.g., selecting the returned candidate(s) with the highest score based on a weighted combination of a plurality of factors).

In an embodiment, consumer AI agent 160C selects only a single candidate provider entity, and immediately configures the selected provider entity as a tool 164 to be used by consumer AI agent 160C. In an alternative embodiment, consumer AI agent 160C selects one or a plurality of candidate provider entities with which to negotiate a service agreement. In this case, if consumer AI agent 160C selects a plurality of candidate provider entities, consumer AI agent 160C may negotiate with each of the plurality of candidate provider entities independently, and select the single candidate provider entity with which it is able to negotiate the best service agreement. In yet another alternative embodiment, consumer AI agent 160C may, if a single candidate provider entity satisfies one or more criteria, select that candidate provider entity and immediately configure the selected provider entity as a tool 164 to be used by consumer AI agent 160C, and otherwise, negotiate with one or more of the candidate provider entities to obtain a service agreement that satisfies the one or more criteria or to obtain the best service agreement possible.

In an embodiment in which consumer AI agent 160C negotiates, consumer AI agent 160C may, for each candidate that has been selected for negotiation, execute a negotiation protocol with that candidate provider entity to determine a service agreement between consumer AI agent 160C and the candidate provider entity. The negotiation protocol, which occurs within the negotiation and transaction layer, may be initiated directly with the candidate provider entity. The negotiation protocol may comprise the sending of an initial offer, followed by zero, one, or more counter-offers, followed by an acceptance and/or confirmation of a service agreement.

For instance, consumer AI agent 160C may generate an offer based on the provider information for the candidate provide entity. This may comprise consumer AI agent 160C generating a prompt, comprising the provider information and an instruction to generate an offer (e.g., using the price or cost model in the provider information as a baseline) according to one or more factors, and applying AI model 162C to the prompt to generate the offer, according to a schema of the negotiation protocol. The factor(s) may comprise minimizing cost, maximizing performance (e.g., speed), maximizing security (e.g., data security), mandating specific capabilities required by the task for which the provider entity is to be used, mandating a maximum cost, and/or the like. The offer may comprise proposed terms of a service agreement, which may include terms representing pricing and/or performance requirements, according to the schema of the negotiation protocol.

Consumer AI agent 160C may send the offer to the candidate, via an application programming interface of the candidate provider entity, defined by the negotiation protocol. In response to the offer, the candidate provider entity may return an acceptance of the offer or a counteroffer. When consumer AI agent 160C receives an acceptance, consumer AI agent 160C may send a confirmation. When consumer AI agent 160C receives a counteroffer, consumer AI agent 160C may either send an acceptance of the counteroffer, send a counteroffer to the counteroffer, or reject the counteroffer.

Consumer AI agent 160C may accept the counteroffer when the terms satisfy one or more criteria, which may be the same criteria discussed above with respect to selecting a provider entity. Alternatively, consumer AI agent 160C may generate a prompt, comprising the counteroffer, the offer, one or more factors, and/or other relevant data, and an instruction to determine whether or not to accept the counteroffer, and apply AI model 162C to the prompt to generate a determination of whether or not to accept the counteroffer. While this assumes that AI model 162C is a generative language model, it should be understood that AI model 162C could be any other suitable type of model that can determine whether or not to accept an offer based on one or more criteria. When accepting the counteroffer, consumer AI agent 160C may send a confirmation to the provider entity, thereby ending the negotiation protocol.

When determining not to accept the counteroffer (e.g., because it does not satisfy the one or more criteria, or AI model 162C determines to reject the counteroffer), consumer AI agent 160C may either send another offer or reject the counteroffer. This determination may be made by AI model 162C or in any other suitable manner. Consumer AI agent 160C may determine to reject a counteroffer when a difference between the most recent offer, made by consumer AI agent 160C to the provider entity, and the counteroffer is too significant (e.g., greater than or equal to a threshold), when the difference between offers and counteroffers stops converging or the rate of convergence is too slow (e.g., rate of convergence is less than or equal to a threshold), after a certain number of counteroffers have been returned during the negotiation protocol, after a certain amount of time has elapsed with no acceptance during the negotiation protocol, when a parallel negotiation with another provider entity has resulted in an acceptance, and/or the like. When rejecting a counteroffer, consumer AI agent 160C may send a rejection to the provider entity, thereby ending the negotiation protocol. Otherwise, consumer AI agent 160C may send a new offer, representing a counteroffer to the counteroffer, to the provider entity.

It should be understood that the exchange of offers and counteroffers may continue until either consumer AI agent 160C or the provider entity accepts an offer from the other party. Each counteroffer may comprise proposed terms of a service agreement, including terms representing pricing and/or performance requirements, according to the schema of the negotiation protocol. Once one party accepts, the other party may confirm the acceptance, and consumer AI agent 160C may configure the provider entity as a tool 164 to be used by consumer AI agent 160C.

The exchange of offers, counteroffers, acceptances, and/or confirmations may be performed using an application programming interface. For example, each provider entity may implement one or more operations, within an application programming interface of the provider entity, for the negotiation protocol. The operation(s) may include an endpoint for submitting an offer and receiving either an acceptance, counteroffer, or rejection, an endpoint for submitting an acceptance of a counteroffer, an endpoint for submitting a rejection of a counteroffer, an endpoint for confirming a service agreement, and/or the like.

In an embodiment, a consumer AI agent 160C may perform a negotiation protocol with a plurality of different provider entities in parallel and/or serially, until a satisfactory service agreement is reached with one of the provider entities. A service agreement may be determined to be satisfactory when the terms of the service agreement satisfy one or more criteria, as mentioned elsewhere herein. In the event that a satisfactory service agreement is obtained with a first provider entity while consumer AI agent 160C is still executing a negotiation protocol with a second provider entity, consumer AI agent 160C may end the negotiation protocol with the second provider entity. In the event that two or more satisfactory service agreements are obtained from two or more provider entities (e.g., during parallel negotiations), consumer AI agent 160C may select the service agreement with the most favorable terms by sending a confirmation to the accepted provider entity, and reject the other service agreement(s) by sending a rejection to each rejected provider entity.

This localized negotiation may complement the performance optimization, which may include cost optimization, discussed elsewhere herein. In particular, this negotiation protocol may ensure that individual transactional decisions by consumer AI agents 160C align with, or are optimized within, broader enterprise-level controls on costs (e.g., economic budgets, energy budgets, limits on ecological footprints, etc.).

Each accepted service agreement, comprising the accepted terms, may be recorded on distributed ledger 180, and the provider entity may provide the service to consumer AI agent 160C according to the service agreement. This provides transparency, and in an embodiment in which distributed ledger 180 is a blockchain, immutability. Once the service agreement is published in distributed ledger 180, there is a verifiable record of the service agreement for all participating parties, as well as for human oversight and arbitration.

Notably, this ledger-based approach eliminates the need for consumer AI agent 160C to repeatedly call the application programming interface of a provider entity or other pricing platform to obtain the provider information. This streamlines the process for the selection of provider entities and the routing of sub-tasks, by consumer AI agents 160C, which in turn, enables real-time market dynamics to be incorporated into the operation of consumer AI agents 160C.

In addition, this ledger-based approach is flexible and extensible, and accommodates any of various cost model and performance metrics, for provider entities, which may include both AI agents 160 and tools 164. Examples of cost models include, without limitation, cost models that determine price per token, per computation, per successful outcome, per API call, and/or the like.

This ledger-based approach also provides a framework for onboarding new provider entities dynamically. In particular, new provider entities can be onboarded by simply publishing their provider information in distributed ledger 180. As soon as a new provider entity's provider information is recorded in distributed ledger 180, that provider entity may be selected and utilized by any consumer AI agent 160C.

In an embodiment, at least some provider entities autonomously generate their own provider information using the cost prediction described elsewhere herein. In particular, a provider entity may utilize discriminator AI agent 160D and/or estimator AI agent 160E to generate a predicted cost for one or more simulated inputs. These simulated inputs could be derived from historical data 172 (e.g., historical inputs for the provider entity or similar provider entities). These simulated predicted costs may be utilized to generate a cost model for the provider entity, to be included in the provider information for that provider entity.

A plurality of potential use cases for decentralized agentic provider selection will now be described. It should be understood that these use cases are merely provided for explication of certain aspects of disclosed embodiments. Not every use case must be present in every embodiment, and the explicitly described use cases do not represent every possible use case. Other use cases will be apparent to those of skill in the art.

In a first use case, embodiments may be used for dynamic onboarding and initial pricing of provider entities. For example, a new provider entity, which may be a newly instantiated AI agent 160 (e.g., customer service bot, research agent, etc.) or newly developed tool 164 (e.g., specialized image processing API, data analytics module, etc.), may come online. This new provider entity may publish provider information, including its base cost model (e.g., price per token, computation, or query), performance parameter(s) (e.g., expected latency between input and response), and one or more capabilities (e.g., offered service(s)), onto distributed ledger 180. This onboarding may leverage the underlying cost prediction capabilities provided by the discriminator AI agent 160D and/or estimator AI agent 160E, as discussed elsewhere herein, to generate the cost model. Advantageously, the new provider entity is immediately available and ready to use, as soon as the provider information is published to distributed ledger 180.

In a second use case, embodiments may be used for the selection of provider entities, for example, with the goal of optimizing cost. A consumer AI agent 160C (e.g., workflow orchestrator, content generator, etc.) may determine, by means of an internal decision-making process (e.g., which uses a distiller, task planner, etc.), that it needs a tool 164 to perform a sub-task (e.g., summarize a document, generate an image, analyze data, etc.). Upon such a determination, consumer AI agent 160C may query distributed ledger 180 to retrieve current, dynamically updated provider information, including a cost model, performance parameter(s), and capability(ies), for the onboarded provider entities (e.g., onboarded via the first use case), with capabilities best matching those required for the sub-task. Consumer AI agent 160C may evaluate the provider information for each of these candidates based on one or more factors, representing its own preferences and/or constraints (e.g., cost budget, latency tolerance, etc.), and select the optimal provider entity from among the candidates based on the evaluation. As discussed elsewhere herein, this evaluation and selection may be performed by AI model 162C. Consumer AI agent 160C may then invoke the selected provider entity (e.g., as a tool 164), for example, via an application programming interface of the provider entity.

In a third use case, embodiments may be used for real-time price updates and demand response. For example, in response to being invoked by consumer AI agent 160C or due to a change in its own operational status (e.g., high load, low resources, peak hours), the selected provider entity may dynamically update its provider information (e.g., cost model, availability, etc.) on distributed ledger 180. This dynamic update reflects real-time supply and demand or internal resource constraints, thereby supporting a live, real-time market. This update mechanism may also be influenced by the performance optimization described herein. For example, in the event that a provider entity is an AI agent 160, a scoring AI agent 160S may throttle the provider entity up or down, via adaptive governance policy 174, and the provider entity may responsively update its provider information in distributed ledger 180 based on the change in operation caused by the throttling. It should be understood that this change in the operation of the provider entity (e.g., which may increase the cost or reduce the performance of the provider entity), as reflected in real time on distributed ledger 180, may trigger a consumer AI agent 160C, which was using that provider entity for a sub-task, to seek a new provider entity for the sub-task (e.g., in the second use case).

In a fourth use case, embodiments may be used for complex negotiation for optimal outcomes. For example, consumer AI agent 160C may identify a plurality of provider entities, capable of performing a required sub-task (e.g., in the second use case), on distributed ledger 180. In this case, instead of immediate selection, consumer AI agent 160C could initiate a brief, automated negotiation protocol with two or more of the candidate provider entities. In each negotiation, consumer AI agent 160C could begin with an offer to each candidate provider entity that proposes different terms (e.g., “Payment X for Performance Y”, “Can you perform [sub-task] for Z tokens?”, etc.). Each provider entity may respond with an acceptance or counteroffer, depending on the current capacity and cost model of that provider entity. Consumer AI agent 160C may commit to the best negotiated service agreement (e.g., by sending a confirmation to the provider entity), and the service agreement, including the agreed-upon terms, may be recorded on distributed ledger 180. Details about the negotiation and execution of the service agreement may also be recorded on distributed ledger 180. In this manner, consumer AI agent 160C may intelligently and autonomously select a provider entity that represents the optimal option, in terms of minimizing cost, maximizing performance, maximizing security, and/or other factors.

In a fifth use case, embodiments are used for human oversight and arbitration. In particular, since all service agreements are recorded on distributed ledger 180, all service agreements are transparently available for review and analysis. For instance, server application 112 or another software entity (e.g., an AI agent 160, designed to analyze spending patterns) could query distributed ledger 180 for service agreements and/or other transactions that pertain to all or a subset of AI agents 160 that are managed by a user or organization. This software entity could then analyze the transaction data, returned by the query, to derive spending or performance patterns for the managed AI agent(s) 160, and generate a dashboard or other screen within a graphical user interface (e.g., of user interface 115 or agentic interface 165). This screen may comprise a visual representation of the derived patterns. This visual representation may comprise text (e.g., natural-language description of the patterns), tables (e.g., a list of all transactions), charts, graphs (e.g., plots of spending over time), and/or the like, which may be collapsible and expandable, interactive, and/or the like. A user, such as an enterprise manager, may log in to the user's user account and view the screen, within the graphical user interface, including the visual representation of spending and/or performance patterns, to review and understand the patterns of the managed AI agent(s) 160. If a specific agent-to-agent or agent-to-tool transaction appears unusually expensive or inefficient, the user may query distributed ledger 180 for precise negotiation and execution details. In the event of a disputed or unexpected cost, the record of distributed ledger 180, which may be immutable (e.g., in an embodiment in which distributed ledger 180 is a blockchain), serves as a verifiable log for human arbitration or auditing. Consequently, any issue may be easily investigated, mediated, and resolved, thereby ensuring accountability in the underlying autonomous transactions.

In a sixth use case, embodiments are used for market-driven discovery of provider entities. For example, a user, such as a developer or enterprise manager, may wish to find a new provider entity for a specific task. The user can browse provider information for available provider entities on distributed ledger 180. For example, server application 112 or another software entity (e.g., an AI agent 160, designed to query distributed ledger 180) may provide a search engine, which provides one or more inputs for searching distributed ledger 180 (e.g., using natural-language expressions and/or other textual expressions, using one or more filters or other selectable search criteria, etc.) and display the results of the search, within a graphical user interface (e.g., of user interface 115 or agentic interface 160). Thus, the user can discover provider entities that offer new, previously unavailable capabilities and their associated pricing. Advantageously, this enables rapid integration of new functionalities into users' AI ecosystems.

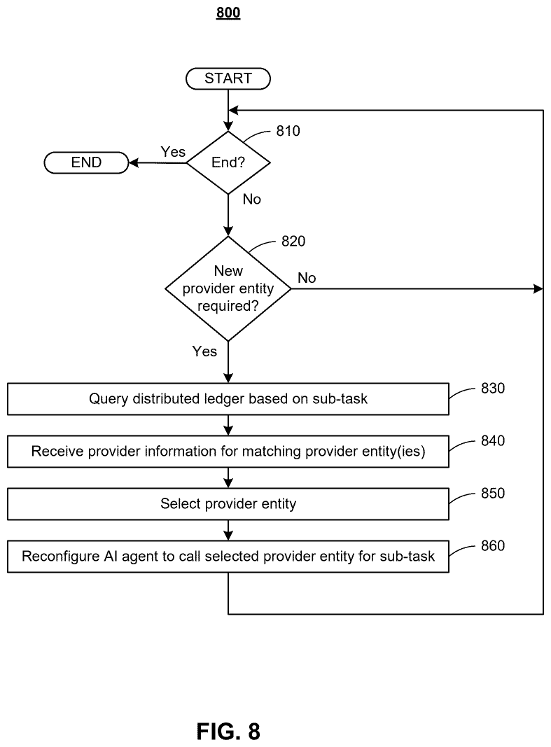

FIG. 8 illustrates an example process 800 for decentralized autonomous agentic provider selection, according to an embodiment. Process 800 may be implemented by consumer AI agent 160C.

While process 800 is illustrated with a certain arrangement and ordering of subprocesses, process 800 may be implemented with fewer, more, or different subprocesses and a different arrangement and/or ordering of subprocesses. Furthermore, any subprocess, which does not depend on the completion of another subprocess, may be executed before, after, or in parallel with that other independent subprocess, even if the subprocesses are described or illustrated in a particular order.

Subprocess 810 may determine whether or not to end process 800. Process 800 may continue for as long as consumer AI agent 160C is operational. Process 600 may end when the operation of consumer AI agent 160C is terminated. However, it should be understood that there may be a plurality of consumer AI agents 160C that are active at any given time. When determining to end (i.e., “Yes” in subprocess 810), process 800 may end. Otherwise, when not determining to end (i.e., “No” in subprocess 810), process 800 may proceed to subprocess 820.

Subprocess 820 may determine whether or not a new provider entity is required for a sub-task of the task being performed by consumer AI agent 160C. For example, consumer AI agent 160C may be in the midst of performing a task during a session with an end client 310. Consumer AI agent 160C may decompose the task into a plurality of sub-tasks, and then perform each of the plurality of sub-tasks. Some of these sub-tasks may be performable by the core of consumer AI agent 160C, AI model 162C, an existing tool 164C, and/or another component in the stack of consumer AI agent 160C. However, in some cases, there may not be a component that is capable of suitably performing a particular sub-task. For instance, the existing components may be wholly incapable of performing the sub-task, or it may be too costly for an existing component to perform the sub-task). In this latter case, consumer AI agent 160C may have utilized discriminator AI agent 160D and/or estimator AI agent 160E, as described elsewhere herein, to obtain a predicted cost for using an existing component (e.g., existing AI model 162E and/or tool 164E), and determined that the predicted cost is prohibitively high, such that it is necessary to find an alternative provider entity to perform the sub-task. When determining that a new provider entity is required (i.e., “Yes” in subprocess 820), process 800 may proceed to subprocess 830. Otherwise, when not determining that a new provider entity is required (i.e., “No” in subprocess 820), process 800 may return to subprocess 810.

Subprocess 830 may query distributed ledger 180, based on the sub-task for which a new provider entity was determined to be required in subprocess 820. As discussed elsewhere herein, distributed ledger 180, which may be a blockchain, may store up-to-date, potentially real-time, provider information for each of a plurality of available provider entities. The provider information for each provider entity may comprise a cost model (e.g., modeling economic, computational, energy, and/or ecological costs) for the provider entity, one or more performance parameters for the provider entity, one or more capabilities of the provider entity, an availability of the provider entity, and/or the like. Thus, consumer AI agent 160C may query distributed ledger 180 for provider information for each of one or more provider entities that has published respective provider information on distributed ledger 180 and for which the respective provider information indicates that the provider entity is capable of performing the sub-task. The query may indicate one or more capabilities required to complete the sub-task.

A provider entity may be any software entity, such as another AI agent 160, a tool 164, or the like. Each provider entity may, upon instantiation of the provider entity, automatically publish its respective provider information to distributed ledger 180. In addition, each provider entity may, after instantiation, automatically and dynamically update its respective provider information on distributed ledger 180, over time, to reflect all changes to the provider information, including potentially real-time changes (e.g., to pricing, available capabilities, etc.) based, for example, on the real-time load on the provider entity, real-time internal resource availability at the provider entity, real-time external market conditions, and/or the like.

Subprocess 840 may, in response to the query in subprocess 830, receive the provider information for one or more matching provider entities that have published provider information on distributed ledger 180. A matching provider entity is one whose capabilities, in the most recently recorded provider information, match those indicated in the query. It should be understood that distributed ledger 180 will generally return provider information for one or more, and in most cases a plurality of, provider entities. However, it is possible that there are no provider entities, registered on distributed ledger 180, that are capable of performing the sub-task, in which case distributed ledger 180 will return no matching provider entities. In this case, consumer AI agent 160C may execute a fallback process, such as notifying end client 310, using a sub-optimal existing or alternative provider entity, returning an error, skipping the sub-task if possible, and/or the like. Such information could be useful to developers or other stakeholders in identifying gaps in agentic coverage. For the sake of simplicity, process 800 assumes that the query returns provider information for at least one provider entity. In the rare event that the query returns no provider information, process 800 could proceed to a fallback process.

Subprocess 850 may select one provider entity from the one or more provider entities, returned in subprocess 840, to perform the sub-task, based on the provider information returned for the one or more provider entities. When subprocess 840 receives provider information for a plurality of provider entities, subprocess 850 may select the provider entity based on one or more factors, such as minimizing cost (e.g., economic, computational, energy, and/or ecological cost), maximizing performance, maximizing security, maximizing mandated capabilities, and/or the like, as discussed elsewhere herein. In an embodiment, the selected provider entity may be required to satisfy one or more criteria. In this case, when none of the plurality of provider entities satisfy the one or more criteria, consumer AI agent 160C may execute a negotiation protocol with one or more of the plurality of provider entities, as discussed elsewhere herein, to produce an acceptable service agreement, and select the provider entity associated with the accepted service agreement. Alternatively, consumer AI agent 160C may execute the negotiation protocol with one or more of the plurality of provider entities, even when the one or more criteria are satisfied, in order to obtain optimal terms, and select the provider entity that agrees to the optimal terms. If consumer AI agent 160C is unable to obtain satisfactory terms (e.g., the best service agreement that is obtainable does not satisfy the one or more criteria), consumer AI agent 160C may execute a fallback process.

When the provider information for only a single provider entity is returned in subprocess 840, subprocess 850 may select this single provider entity. However, even in this case, the selected provider entity may be required to satisfy one or more criteria. If the provider entity does not satisfy the one or more criteria, consumer AI agent 160C may execute the negotiation protocol to attempt to obtain a service agreement that satisfies the one or more criteria. Alternatively, consumer AI agent 160C may execute the negotiation protocol, even when the one or more criteria are satisfied, in order to obtain optimal terms. If consumer AI agent 160C is unable to obtain satisfactory terms (e.g., the best service agreement that is obtainable does not satisfy the one or more criteria), consumer AI agent 160C may execute a fallback process.

In summary, subprocess 850 selects the optimal provider entity for a given sub-task. This optimality may be defined by one or more factors, such as minimizing cost, maximizing performance, maximizing security, maximizing mandated capabilities, and/or the like. The selection process may comprise a rule-based selection, mathematical selection, AI-based selection (e.g., using AI model 162C, as discussed elsewhere herein), and/or the like, based on the factor(s). Additionally or alternatively, the selection process may comprise executing a negotiation protocol between consumer AI agent 160C and each of one or more provider entities, to produce an optimal service agreement, and selecting the provider entity for which the optimal service agreement was determined. The service agreement, between consumer AI agent 160C and the selected provider entity, resulting from the negotiation, may be recorded on distributed ledger 180. This service agreement may comprise one or more terms for provision of the sub-task to be performed by the provider entity.

Subprocess 860 may reconfigure consumer AI agent 160C to call the selected provider entity for the sub-task. Calling the selected provider entity may comprise executing a remote procedure call of an operation within an application programming interface of the selected provider entity. The reconfiguration may comprise adding the selected provider as a tool 164C that may be used by consumer AI agent 160C immediately and/or in the future. For example, consumer AI agent 160C may add tool 164C to a local catalog of tools 164C that can be utilized by consumer AI agent 160C. In the event that consumer AI agent 160C is performing subprocess 800, while performing a task that requires the sub-task for which the provider entity was selected, consumer AI agent 160C may immediately call the provider entity to perform the sub-task. In this manner, consumer AI agent 160C may autonomously “learn” new capabilities. In the future, if consumer AI agent again has need of the sub-task, consumer AI agent 160C may consult the registry, determine that the added provider entity is capable of performing the sub-task, and call the provider entity to perform the sub-task. It should be understood that consumer AI agent 160C may automatically call the selected provider entity to perform the sub-task in any instance in which consumer AI agent 160C is performing a task that requires the sub-task.

Advantageously, process 800, in combination with the registration of provider entities on distributed ledger 180, enables consumer AI agents 160C to autonomously select provider entities. As a result, consumer AI agents 160C can adapt and evolve, over time, by automatically acquiring new capabilities as the need arises. In addition, each provider entity is able to autonomously onboard itself, by registering itself on distributed ledger 180. In other words, disclosed embodiments enable AI agents 160 to grow on their own, from an autonomously grown registry of provider entities, all within in a scalable framework.

### 6. Example Embodiments

In an embodiment, at least one scoring AI agent 160S is provided within computing environment 150 or with access to computing environment 150. Scoring AI agent 160S may utilize an AI model 162S that has learned the behavior of one or more, and generally a plurality of, AI agents 160 (e.g., by training an AI model 162S on the learned behavior). Behavior of AI agents 160 may be learned from a plurality of components in the stack of each AI agent 160, including the cores of AI agents 160, AI models 162 utilized by AI agents 160, contexts used for AI models 162 by AI agents 160, tools 164 utilized by AI agents 160, and/or the like. Scoring AI agent 160S may generate a score for each of one or more performing AI agents 160P, that represents a comparison between performance telemetry 320 for performing AI agent 160P and historical performance telemetry (e.g., as stored in historical data 172) for performing AI agent 160P and/or similar AI agents 160. Scoring AI agent 160S is able to analyze the behavior of performing AI agent 160P across a plurality of relevant dimensions, including model utilization, model routing, computational time, resource utilization, tool utilization, inter-agent communications, and/or the like. When the variance of performance telemetry 320 for a performing AI agent 160P from an established or expected pattern, as represented by the score, is significant (e.g., satisfies a threshold), scoring AI agent 160S may automatically throttle one or more parameters in adaptive governance policy 174, to thereby trigger a change in operation of the performing AI agent 160P. This automated throttling down of performing AI agent 160P by scoring AI agent 160S can prevent performing AI agent 160P from wasting computational resources, exceeding budgets on computational resources, model costs, tool costs, ecological costs, energy draws, and/or the like, causing brownouts, and/or the like. In some cases, scoring AI agent 160S may throttle performing AI agent 160P back up, in response to subsequent improvements in performance telemetry 320 of performing AI agent 160P. In summary, scoring AI agent 160S can throttle performing AI agents 160P down and/or up based on observed patterns in their performances, by autotuning one or more parameters in adaptive governance policy 174, to thereby optimize overall agentic performance.

In an embodiment, cost prediction, implemented using a discriminator AI agent 160D and estimator AI agent 160E, is introduced into computing environment 150. Discriminator AI agent 160D searches historical data 172 to identify one or more input identifiers for similar inputs to a current input. Estimator AI agent 160E retrieves relevant data, associated with the found input identifier(s) in historical data 172, and potentially a cost model (e.g., in provider information recorded on distributed ledger 180), and predicts the cost of performing an inference (e.g., representing a task given to a performing AI agent 160P) on the current input. This predicted cost, which is predicted before the inference is performed and actual costs are incurred, may be used by an end client 310, performing AI agent 160P, or intermediary 520, depending on the implementation, to determine whether or not to perform the inference. Thus, inferences that would be too costly (e.g., in terms of economic, computational, energy, and/or ecological budget) can be blocked and avoided, or at least brought to the attention of end client 310 prior to the cost being incurred. Such an embodiment also prevents the occurrence of endless loops in the operation of performing AI agents 160P.

In an embodiment, decentralized autonomous agentic provider selection, implemented using distributed ledger 180 and/or a negotiation and transaction layer, is introduced into AI agents 160. Provider entities may onboard themselves by publishing provider information to distributed ledger 180, and continually updating this provider information to reflect the most current information and/or real-time conditions. When needing a new provider entity for a sub-task, consumer AI agents 160C may query distributed ledger 180 to obtain the provider information for provider entities that are capable of performing the sub-task. Each consumer AI agent 160 may select a provider entity to perform the sub-task, based on one or more factors, and utilize that selected provider entity to complete its task. This enables the universe of provider entities to grow autonomously, and enables AI agents 160 to autonomously evolve over time by automatically acquiring new capabilities when needed.

An embodiment may comprise or consist of one or more of the features of performance optimization, cost prediction, and decentralized autonomous agentic provider selection. For example, a first embodiment may comprise or consist of only performance optimization. A second embodiment may comprise or consist of only cost prediction. A third embodiment may consist of only decentralized autonomous agentic provider selection. A fourth embodiment may comprise or consist of only performance optimization and cost prediction. A fifth embodiment may comprise or consist of only performance optimization and decentralized autonomous agentic provider selection. A sixth embodiment may comprise or consist of only cost prediction and decentralized autonomous agentic provider selection. A seventh embodiment may comprise or consist of all three of performance optimization, cost prediction, and decentralized autonomous agentic provider selection.

As discussed throughout the present disclosure, the features of performance optimization, cost prediction, and decentralized autonomous agentic provider selection may intersect with each other in a synergistic manner. For example, a predicted cost that exceeds a budget may result in the modification of adaptive governance policy 172 to throttle down a performing AI agent 160P to bring actual costs down. As another example, predicted costs may be used by provider entities to autonomously generate cost models for recordation on distributed ledger 180. As yet another example, a predicted cost for an existing provider entity may trigger a consumer AI agent 160C to autonomously select a new provider entity. As yet another example, the ability to block inferences and/or throttle down performing AI agents 160, when the predicted costs would exceed a budget, prevents endless-loop AI agents 160, which may proliferate with the newfound ability of AI agents 160 to evolve autonomously using decentralized agentic provider selection.

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

As used herein, the terms “comprising,” “comprise,” and “comprises” are open-ended. For instance, “A comprises B” means that A may include either: (i) only B; or (ii) B in combination with one or a plurality, and potentially any number, of other components. In contrast, the terms “consisting of,” “consist of,” and “consists of” are closed-ended. For instance, “A consists of B” means that A only includes B with no other component in the same context.

Combinations, described herein, such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, and any such combination may contain one or more members of its constituents A, B, and/or C. For example, a combination of A and B may comprise one A and multiple B's, multiple A's and one B, or multiple A's and multiple B's.

What is claimed is:

1. A method comprising using at least one hardware processor to, by a scoring artificial intelligence (AI) agent, while a performing AI agent is performing inference using a performing AI model:
receive performance telemetry for the performing AI agent;
determine a score representing a deviation between an actual performance of the performing AI agent and an expected performance of the performing AI agent based on the performance telemetry; and
modify a value of each one or more parameters in an adaptive governance policy based on the score, wherein the adaptive governance policy governs operation of the performing AI agent, and wherein the modification of the value of each of the one or more parameters triggers a change in the operation of the performing AI agent while the performing AI agent is performing the inference.

2. The method of claim 1, wherein the adaptive governance policy comprises a plurality of parameters that are organized into a plurality of hierarchical levels.

3. The method of claim 2, wherein the plurality of hierarchical levels comprises a first level that is specific to the performing AI agent, and at least one second level that represents a group of two or more performing AI agents.

4. The method of claim 1, wherein the performing AI agent is a conversational AI agent that converses with a user using natural language.

5. The method of claim 1, wherein the performance telemetry comprises one or both of a log or metadata for each of one or more components in a stack of the performing AI agent.

6. The method of claim 5, wherein the one or more components are a plurality of components.

7. The method of claim 6, wherein the plurality of components comprises two or more of a core of the performing AI agent, the performing AI model, a model router utilized by the performing AI agent, a tool utilized by the performing AI agent, or an inter-agent communication protocol utilized by the performing AI agent to communicate with other AI agents.

8. The method of claim 6, wherein triggering the change in the operation of the performing AI agent comprises communicating directly with one or more of the plurality of components.

9. The method of claim 1, further comprising using the at least one hardware processor to, when the change in the operation is triggered, adjusting one or more configurable parameters of each of one or more components in a stack of the performing AI agent.

10. The method of claim 9, wherein the adjustment is performed by the performing AI agent.

11. The method of claim 9, wherein the adjustment is performed by a software entity, other than the performing AI agent, via an application programming interface of each of the one or more components.

12. The method of claim 9, wherein the one or more components are a plurality of components.

13. The method of claim 12, wherein the plurality of components comprises two or more of a core of the performing AI agent, the performing AI model, a model router utilized by the performing AI agent, a tool utilized by the performing AI agent, or an inter-agent communication protocol utilized by the performing AI agent to communicate with other AI agents.

14. The method of claim 1, wherein the scoring AI agent receives the performance telemetry as a stream from an event-driven architecture.

15. The method of claim 13, wherein the event-driven architecture is a publish-and-subscribe system.

16. The method of claim 1, wherein the change in operation comprises throttling down a utilization of one or more resources by the performing AI agent.

17. The method of claim 16, wherein throttling down the utilization of one or more resources by the performing AI agent comprises limiting the utilization of the one or more resources.

18. The method of claim 1, wherein the performing AI model comprises a generative language model.

19. A system comprising:
at least one hardware processor; and
at least one scoring AI agent configured to, when executed by the at least one hardware processor, perform the method of claim 1.

20. A non-transitory computer-readable medium having instructions stored thereon, wherein the instructions, when executed by a processor, cause the processor to perform the method of claim 1.
